(19) United States
(12) Patent Application Publication
(10) Pub. No.: US 2002/0034606 A1
(43) Pub. Date: Mar. 21, 2002

(54) Low weight cushioned carpet, carpet tile and method

(76) Inventors: Scott C. Miller, LaGrange, GA (US); Kenneth B. Higgins, LaGrange, GA (US)

Correspondence Address: Milliken & Company, P.O. Box 1927, Spartanburg, SC, 29304, US

(21) Appl. No.: 09/864,478

(22) Filed: May 23, 2001

Related U.S. Application Data
(63) Continuation-in-part of application No. 09/587,654, filed on Jun. 5, 2000.

(51) Int. Cl. B32B 5/00; D05C 17/00; B32B 33/00

(52) U.S. Cl. 428/95; 428/96; 428/97; 156/72; 156/253

(57) ABSTRACT

An improved low weight cushioned flooring, floor covering, carpet, carpet tile, and method is provided. The low weight, cushioned carpet includes a low weight primary carpet having a base and a plurality of pile-forming yarns projecting outwardly from one side. A layer of reinforcement material is bonded to the base on the side opposite the pile forming yarns. The reinforcement layer is adjacent to and may be embedded in, a cushion layer of a polymer such as a polyurethane. An apparatus and process for forming the low weight cushioned carpet or carpet tile of the present invention are also provided.

### CROSS REFERENCE TO RELATED APPLICATIONS

This application is a continuation-in-part of and claims priority to U.S. patent application Ser. No. 09/587,654, filed Jun. 5, 2000, and hereby incorporated by reference.

### FIELD OF THE INVENTION

The present invention relates to cushioned, foam backed, or cushion backed surface covering, wall covering, floor covering, flooring material, carpet, carpet tile, or the like, and more particularly, to a low weight, cushioned carpet, carpet tile and method. A process and apparatus for forming the cushion backed floor covering, carpet or carpet tile of the present invention are also provided.

### BACKGROUND OF THE INVENTION

As described in U.S. Pat. Nos. 4,522,857, 5,540,968, 5,545,276, 5,948,500, and 6,203,881 (all hereby incorporated by reference herein) carpet and carpet tiles having cushioned backings are well known to those of skill in the art. As described in the U.S. Pat. No. 5,948,500 and as shown herein, an example of a tufted carpet product is illustrated in FIG. 1 A and an example of a bonded carpet product is illustrated in FIG. 1B.

In the tufted carpet of FIG. 1A, a primary carpet fabric 12 is embedded in an adhesive layer 16 in which is embedded a layer of glass scrim or non-woven material. A foam base composite 19 is likewise adhesively bonded to the adhesive layer 16. In the tufted carpet illustrated in FIG. 1A, the primary carpet fabric 12 includes a loop pile layer 20 tufted through a primary backing 22 by a conventional tufting process and held in place by a pre-coat backing layer of latex 24 or other appropriate adhesives including a hot melt adhesive or the like. The foam base composite 19 of the tufted carpet product includes an intermediate layer 26 molded to a layer of urethane foam 28 as illustrated.

The bonded carpet product (FIG. 1B) employs the same type of foam base composite 19 adhesively bonded by adhesive laminate layers 16. However, the primary bonded carpet fabric 12 has somewhat different components from that of the tufted product in that it has cut pile yarns 34 implanted in a PVC, latex, or hot melt adhesive 36 having a woven or non-woven reinforcement or substrate layer 38 of fiberglass, nylon, polypropylene, or polyester.

The practice utilized in forming the product disclosed in the U.S. Pat. No. 4,522,857 and other known products involves pre-forming and curing the foam base composite 19 of urethane foam and backing material by practices such as are disclosed in U.S. Pat. Nos. 4,171,395, 4,132,817 and 4,512,831, to Tillotson (all hereby incorporated by reference herein). As described in these patents, only after this foam base composite is formed and cured to some degree as a modular component, is it laminated to the carpet base.

As described in the above-mentioned U.S. Pat. No. 5,948,500, the cost associated with such modular formation and assembly practices may be reduced by a simplified operation in which a primary carpet fabric, either with or without a stabilizing layer of scrim or the like, is laid directly into a polyurethane-forming composition and thereafter curing the polyurethane. The process can be made even more efficient if the polyurethane-forming composition requires no pre-curing prior to joining the carpet base.

Prior to the invention described in the U.S. Pat. No. 5,948,500, the known processes directed to the application of the polyurethane cushioned backings to fabric substrates relied on the extremely close control of temperature in both the polyurethane composition and the adjoined fabric layer to effect stability through pre-cure of the polyurethane prior to lamination of the primary carpet to form a composite structure. Such pre-cure had been largely considered necessary in order to yield a stable foam structure to which the primary carpet backing could be applied. The application of heat to the polyurethane composition prior to joiner of the heated fabric backing caused polymer cross linking which had been thought to be necessary to stabilize the foam mixture to a sufficient degree to prevent the collapse of the foam.

The invention described in the U.S. Pat. No. 5,948,500 also provides a particularly simple composite structure amendable to in-situ formation of a stable cushion carpet composite which is not believed to have been previously utilized. Specifically, it had not been previously recognized that a single process could be used to bring all the layers of the cushioned carpet composite together by laying a primary carpet fabric, either with or without some degree of preheat, directly into a mechanically frothed polyurethane-forming composition prior to curing the polyurethane and without an intermediate layer of material.

As indicated, the prior art carpet forming processes typically required the separate formation of a foam base composite having a backing layer and a layer of urethane foam. The backing layer is then used as an intermediate layer to which a primary carpet fabric and reinforcing layer can be adhesively bonded.

As described in the U.S. Pat. No. 5,948,500, the base of the primary carpet fabric is adhesively bonded to a layer of non-woven glass reinforcement material to form a preliminary composite. A puddle of polyurethane-forming composition is simultaneously deposited across a woven or non-woven backing material. The preliminary composite and the polyurethane-forming composition are thereafter almost immediately brought together with the preliminary composite being laid into, and supported by, the polyurethane-forming puddle. The entire structure is then heated to cure the polyurethane forming composition. The preliminary composite may be slightly heated to about 120 degree F to improve heating efficiency although the process may likewise be carried out without such preheating.

A superior cushion backed carpet tile or modular cushion back carpet tile on the market today, for example, sold under the trademark Comfort Plus® by Milliken & Company of LaGrange, Georgia has a primary carpet fabric with a face weight of about 20 to 40 oz/yd², a hot melt layer of about 38 to 54 oz/yd², a cushion of about 0.10 to 0.2 inches thick, a weight of about 28-34 oz/yd², and having a density of about 18 lbs. per cubic foot, and an overall product height of about 0.4-0.8 inches. This superior cushion back carpet tile provides excellent resilience and under foot comfort, exhibits performance characteristics that rate it for very heavy commercial use, and has achieved a notable status throughout the industry as having excellent look, feel wear, comfort, and cushion characteristics, performance, properties, and the like. Such a superior cushion backed carpet tile is relatively expensive to produce due to the high quality and quantity of materials utilized.

Although attempts have been made at reducing the cost of floor coverings or carpet by using lower quality materials, such attempts have not been particularly successful. Low quality products tend to have a less than desirable look, feel, wear, comfort, cushion, and the like. Hence, such products have not been accepted in the industry and have failed commercially.

### OBJECTS AND SUMMARY OF THE PRESENT INVENTION

In view of the foregoing it is a general object of the present invention to provide a low weight foam backed or cushion backed surface covering, wall covering, floor covering, flooring material, carpet, or carpet tile.

It is a further object of the present invention to provide a carpet or carpet tile having a low face weight.

It is another object of the present invention to provide a carpet tile having a carpet with a face weight of less than or equal to about 15 oz/yd².

It is another object of the present invention to provide a carpet tile having a resilient or hot melt layer of less than or equal to about 50 oz/yd².

It is yet another object of the present invention to provide a carpet tile having a lightweight cushion.

It is a further object of the present invention to provide a carpet tile having a lightweight cushion of about 0.04 to 0.12 inches thick, preferably 0.04-0.09 inches thick.

It is still another object of the present invention to provide a carpet tile having a lightweight cushion with a density of less than or equal to about 20 lbs. per cubic foot.

It is yet another object of the present invention to provide a carpet tile having a lightweight cushion with a density of about 13-16 lbs. per cubic foot.

It is a further object of the present invention to provide a carpet tile having a light weight cushion with a weight of less than or equal to about 26 oz/yd².

It is a further object of the present invention to provide a low weight modular carpet tile having resilience and under foot comfort.

It is still another object of the present invention to provide a low weight modular carpet tile exhibiting performance characteristics that rate it for heavy commercial use.

It is a further object of the present invention to provide a method of forming a low weight surface covering, wall covering, flooring, carpet, carpet composite, carpet tile, or the like.

It is another object of the present invention to provide a method of forming a low weight modular carpet tile having resilience, under foot comfort, and performance characteristics that rate it for heavy commercial use.

It is an object of the present invention to provide a low weight cushioned carpet composite or tile wherein a reinforcement layer is disposed, at least partially, within a polymer mass which is adjacent to a primary carpet with such primary carpet being laid in-situ into a puddle of the polymer which forms the cushion.

It is a related object of the present invention to provide a low weight cushioned carpet composite or tile wherein a primary carpet fabric is joined to a reinforcement layer and laid in-situ into a polyurethane-forming composition which has not undergone a pre-cure operation.

It is a further object of the present invention to provide a process for the formation of a low weight cushioned carpet composite or tile wherein a reinforcement layer is adhered to the base of a primary carpet fabric, a polyurethane-forming composition is applied to a non-woven backing layer, and the primary carpet fabric with the adhered reinforcement layer is attached to the polyurethane-forming composition to form the carpet composite.

It is still a further related object of the present invention to provide a continuous process for the in-situ formation of a cushioned carpet composite wherein a reinforcement layer is adhered between a primary carpet base and a backing layer through the in-situ application of a polyurethane forming composition without the need for an intermediate adhesion step.

It is still a further related object of the present invention to provide an apparatus for carrying out the continuous in-situ formation of a cushioned carpet composite.

It is yet another object that the low weight carpet composite and low weight carpet tile of the present invention may be printed with orientation independent designs or designs having the ability to seam properly without cutting the tiles in register with the design and to allow the carpet to be installed monolithically as well as by conventional quarter turn “Parquet”, or by ashler (brick). The preferred installation techniques are monolithic or ashler with or without floor adhesives.

In accordance with an exemplary embodiment of the present invention, a low weight modular carpet composite which may be cut to form low weight modular carpet tiles includes a low weight primary carpet or greige carpet having, for example, a face weight of less than or equal to about 15 oz/yd², a hot melt layer of less than or equal to about 50 oz/yd², and a lightweight cushion of about 0.04-0.12 inches thick. The cushion may have a density of about 13-16 lbs. per cubic foot or less.

Such a low weight modular carpet composite or low weight modular carpet tile has unexpectedly been found to have excellent look, wear cushion, resilience, under foot comfort, and exhibits performance characteristics that rate it for heavy commercial use. Hence, such a low weight carpet composite or low weight carpet tile may be used in place of standard weight cushion backed or hard backed carpet tile, or broadloom thus reducing cost, reducing material requirements, reducing weight, reducing energy requirements, reducing environmental impact, and the like.

In accordance with a particular example of the present invention, a low weight modular carpet composite is cut into modular carpet tiles or carpet squares, for example, 18 inches×18 inches, 36 inches×36 inches, 50 cm×50 cm, 1 meter×1 meter, 48 inches×48 inches, or the like.

Also, the low weight carpet composite or low weight carpet tile of the present invention may be installed on site or on flooring by all of the conventional installation techniques as well as can be constructed for adhesive-free installation, self-stick, or the like.

Also, the low weight carpet composite and low weight carpet tile of the present invention may be printed with orientation independent designs or designs having the ability to seam properly without cutting the tiles in register with the design and to allow the carpet to be installed monolithically as well as by conventional quarter turn “Parquet”, or by ashler (brick). The preferred installation techniques are monolithic or ashler with or without floor adhesives.

In accordance with the present invention, it has been unexpectedly discovered that a carpet composite or carpet tile having excellent look, feel, wear, resilience, and under foot comfort and exhibiting performance characteristics that rate it for heavy commercial use can be formed by combining a low weight primary carpet with a hot melt or resilient layer and a lightweight cushion.

In accordance with the present invention, a low weight modular carpet tile is provided having an overall height of about 0.20 to 0.5 inches thick depending on the construction of the carpet tile (the number of layers or components) and which can be cut in any conventional shape or size.

The low weight carpet composite of the present invention is especially adapted to be cut for use as low weight modular carpet tiles, but also finds applicability as other carpet or flooring, such as, carpet, broadloom area rugs, runners, floor mats, or the like.

It is a feature of the present invention to provide a low weight, cushioned carpet composite or carpet tile including a primary carpet fabric in laminar relation to a reinforcement layer wherein such reinforcement layer is at least partially embedded in a polyurethane foam layer which is disposed adjacent to a non-woven backing layer. The reinforcement layer may be bonded to the base of the primary carpet fabric by the polyurethane foam or by a separate adhesive.

It is a feature of the present invention to provide a low weight, cushioned carpet composite or carpet tile including a primary carpet fabric in laminar relation to a polyurethane foam layer which is disposed adjacent to a non-woven backing layer.

It is a feature of the present invention to provide a low weight, cushioned carpet composite or carpet tile including a primary carpet fabric in laminar relation to a reinforcement layer and a polyurethane foam layer. The reinforcement layer may be bonded to the base of the primary carpet fabric by the polyurethane foam or by a separate adhesive.

It is a further feature of the present invention to provide a process for forming a cushioned carpet composite including the simultaneous continuous steps of adhering a woven or non-woven reinforcement material to the base of a primary carpet fabric; depositing a puddle of a polyurethane-forming composition across a backing layer or support structure and laying the primary carpet fabric and adhered reinforcement material into the puddle of polyurethane-forming composition deposited on the backing layer.

It is a further feature of the present invention to provide a process for forming a cushioned carpet composite including the steps of adhering a woven or non-woven reinforcement material to the base of a primary carpet fabric and adhering a polyurethane foam and backing layer to the reinforcement material.

It is a further feature of the present invention to provide a process for forming a cushioned carpet composite including the simultaneous continuous steps of forming a primary carpet fabric; forming a polyurethane foam layer, and adhering the primary carpet fabric to the polyurethane foam layer.

It is another feature of the present invention to provide a single step process for forming a cushioned carpet composite including applying a polyurethane-forming composition adjacent a primary carpet fabric and a non-woven backing layer with the polyurethane-forming composition at least partially holding an intermediate layer of reinforcement material.

It is yet another feature of the present invention to provide a process for forming a cushioned carpet composite including applying a polyurethane-forming composition adjacent a primary carpet fabric with the polyurethane-forming composition at least partially holding an intermediate layer of reinforcement material.

It is still another feature of the present invention to provide a process for forming a cushioned carpet composite including applying a polyurethane-forming composition adjacent a primary carpet fabric and a non-woven backing layer

It is yet a further feature of the present invention to provide an apparatus for use in the continuous in-situ formation of a cushioned carpet composite wherein the apparatus includes a polymer application unit for depositing a polyurethane-forming composition or other suitable polymer in combination with an adhesive application apparatus for adhering a reinforcement layer to the base of a primary carpet fabric. The polymer application unit and the adhesive application unit being simultaneously operable in controlled relation to one another such that the primary carpet with the adhered reinforcement layer may be laid directly into the polymer.

It is yet a further feature of the present invention to provide an apparatus for use in the formation of a cushioned carpet composite wherein the apparatus includes a polymer application unit for depositing a polyurethane-forming composition or other suitable polymer to the base of a primary carpet fabric.

It is yet a further feature of the present invention to provide an apparatus for use in the formation of a cushioned carpet composite wherein the apparatus includes an adhesive application apparatus for adhering a reinforcement layer to the base of a primary carpet fabric.

In accordance with one aspect of the present invention, a cushioned carpet, composite, or tile is provided. The cushioned carpet includes a primary carpet having a primary base and a plurality of pile-forming yarns projecting outwardly from one side. A layer of reinforcement material is bonded to the primary base on the side away from the pile-forming yarns. The reinforcement material is adjacent to, and embedded at least partially in, a cushion layer of polymer such as polyurethane. There is preferably no additional adhesive between the cushion layer and the layer of reinforcement material. An optional backing material is preferably disposed on the underside of the cushion layer. The backing material may include an adhesive backing on the side away from the cushion layer.

In accordance with one aspect of the present invention, a cushioned carpet, composite, or tile is provided. The cushioned carpet includes a primary carpet having a primary base and a plurality of pile-forming yarns projecting outwardly from one side. A layer of reinforcement material is bonded to the primary base on the side away from the pile-forming yarns. The reinforcement material is adjacent to a cushion layer of polymer such as polyurethane. An optional backing material is preferably disposed on the underside of the cushion layer. The backing material may include an adhesive backing on the side away from the cushion layer.

In accordance with one aspect of the present invention, a cushioned carpet, composite, or tile is provided. The cushioned carpet includes a primary carpet having a primary base and a plurality of pile-forming yarns projecting outwardly from one side. A cushion layer is bonded to the primary base on the side away from the pile-forming yarns. A reinforcement material may be embedded in the cushion layer of polymer such as polyurethane. The cushion layer may be bonded to the primary carpet by a layer of hot melt. An optional backing material is preferably disposed on the underside of the cushion layer. The backing material may include an adhesive backing on the side away from the cushion layer.

In accordance with another aspect of the present invention, a process for making a cushioned carpet is provided. The process involves obtaining a primary carpet fabric comprising a plurality of pile-forming yarns extending outwardly from one side of a primary base. A layer of reinforcement material is adhered to the primary carpet fabric on the side, from which the pile-forming yarns do not extend, thereby forming a preliminary composite. A puddle of polymer such as a polyurethane-forming composition is applied to one side of a backing material and preferably doctored to desired thickness to form a cushion layer. The preliminary composite is then adhered to the cushion layer. Following this mating operation, the carpet is cut to size or into tiles.

In accordance with another aspect of the present invention, a process for making a cushioned carpet is provided. The process involves obtaining a primary carpet fabric comprising a plurality of pile-forming yarns extending outwardly from one side of a primary base. A puddle of polymer such as a polyurethane-forming composition is applied to one side of a backing material and preferably doctored to desired thickness. The primary carpet fabric is then laid into the puddle of polymer without curing. Following this mating operation, the polymer is preferably heat cured and the carpet is cut into tiles.

In accordance with another aspect of the present invention, a process for making a cushioned carpet is provided. The process involves obtaining a primary carpet fabric comprising a plurality of pile-forming yarns extending outwardly from one side of a primary base. A layer of reinforcement material is adhered to the primary carpet fabric on the side, from which the pile-forming yarns do not extend, thereby forming a preliminary composite. A puddle of polymer such as a polyurethane-forming composition is applied to one side of a backing material and preferably doctored to desired thickness. The preliminary composite is then laid into the puddle of polymer without curing. Following this mating operation the polymer is preferably heat cured and the carpet is cut into tiles.

In accordance with still another aspect of the present invention, an apparatus for use in forming a cushioned carpet composite is provided, comprising: a reinforcement bonding unit for bonding a layer of reinforcement material to the underside of a primary carpet fabric to form a preliminary carpet composite; a polymer application unit for dispersing a polyurethane-forming composition across the surface of a carrier fabric; a mating unit for laying said preliminary carpet composite into said polyurethane-forming composition; and means for heat curing the polyurethane-forming composition subsequent to said preliminary composite being laid into said polyurethane-forming composition; wherein said reinforcement bonding unit, said polymer application and said mating unit are operable in a continuous, simultaneous manner.

In accordance with still another aspect of the present invention, an apparatus for use in forming a cushioned carpet composite is provided, comprising: a reinforcement bonding unit for bonding a layer of reinforcement material to the underside of a primary carpet fabric to form a preliminary carpet composite; a polymer application unit for dispersing a polyurethane-forming composition across the surface of a carrier fabric; means for heat curing the polyurethane-forming composition to form a cushion layer, and a mating unit for joining the carpet composite and cushion layer.

In accordance with still another aspect of the present invention, an apparatus for use in forming a cushioned carpet composite is provided, comprising: a reinforcement bonding unit for bonding a layer of reinforcement material to the underside of a primary carpet fabric and to the top side of a cushion layer to form a carpet composite.

In accordance with another embodiment of the present invention, a modular carpet tile is manufactured by:

tufting broadloom at a weight of 15 oz/yd² or less,

printing a design in broadloom form,

applying a cushion backing system, and

cutting into square tiles.

The low weight modular carpet tile of the present invention is aesthetically pleasing and exhibits performance characteristics that rate it for a heavy commercial application. The combination of a low weight (<15 oz/yd²) tufted carpet, hot melt layer, and cushion backing also provides resilience and under-foot comfort.

The low weight carpet, composite, and tile of the present invention is especially suited for broadloom because of:

a. Tufted construction

b. Applied design

c. Attached cushion backing

The low weight carpet, composite, and tile of the present invention is well adapted for modular applications because of:

a. Post applied design

b. Tufted construction

c. Cushion backing

### BRIEF DESCRIPTION OF THE DRAWINGS

FIG. 1A is a cut-away view of a tufted carpet with a cushioned composite structure.

FIG. 1B is a cut-away side view of a bonded carpet incorporating a cushioned composite structure.

FIG. 2 is a schematic view illustrating an exemplary embodiment of the apparatus and process of the present invention.

FIG. 3A is a cut-away side view of a tufted carpet incorporating a structure formed by the apparatus and process of the present invention as illustrated in FIG. 2.

FIG. 3B is a cut-away side view of a bonded carpet incorporating a structure formed by the apparatus and process of the present invention as illustrated in FIG. 2.

FIG. 4A is a cut-away side view of an alternative embodiment of a tufted carpet having no reinforcement layer.

FIG. 4B is a cut-away side view of an alternative embodiment of a bonded carpet having no reinforcement layer.

FIG. 5 is a schematic view illustrating an alternative apparatus and process according to the present invention for forming a cushioned carpet composite without separate adhesive bonding between the primary carpet and the reinforcement layer.

FIG. 6A is a cut-away side view of an alternative structure for a tufted carpet formed by the apparatus and process illustrated in FIG. 5.

FIG. 6B is a cut-away side view of an alternative structure for a bonded carpet formed by the apparatus and process illustrated in FIG. 5.

FIG. 7 is a schematic view illustrating yet another alternative apparatus and process according to the present invention for forming a cushioned carpet composite without separate adhesive bonding between the primary carpet and the reinforcement layer as illustrated in FIGS. 6A and 6B.

FIG. 8 is a schematic flow diagram of the production of low weight modular carpet tiles in accordance with one embodiment of the present invention.

FIG. 9 is a tabular representation of the materials, dimensions, temperatures, and the like used in the process of FIG. 8.

FIGS. 10-18 are cut-away side views of respective tufted and bonded low weight carpet, composite, or tiles in accordance with different embodiments or aspects of the present invention.

Although FIGS. 10A and 11-18 show a looped pile in the primary carpet and FIG. 10B shows a bonded primary carpet, it is to be understood that a bonded or tufted loop and/or cut pile may be used and that the pile may be sculptured, printed, dyed, and or the like as desired.

FIGS. 19 and 19A are respective schematic illustrations of alternative apparatus and process in accordance with selected embodiments of the present invention.

While the invention will be described and disclosed in connection with certain preferred embodiments and procedures, it is by no means intended to limit the invention to such specific embodiments and procedures. Rather it is intended to cover all such alternative embodiments, procedures, and modifications thereto as may fall within the true spirit and scope of the invention as defined and limited only by the appended claims.

### DETAILED DESCRIPTION

In accordance with the present invention, a low weight surface covering, wall covering, flooring, carpet, floor covering, carpet composite, or modular carpet tile and method is provided which is aesthetically pleasing, exhibits performance characteristics that rate it for heavy commercial use, has resilience and underfoot comfort, and which may be dyed, printed, and installed as can be done with conventional foam backed or cushion backed carpet, composite, or tiles.

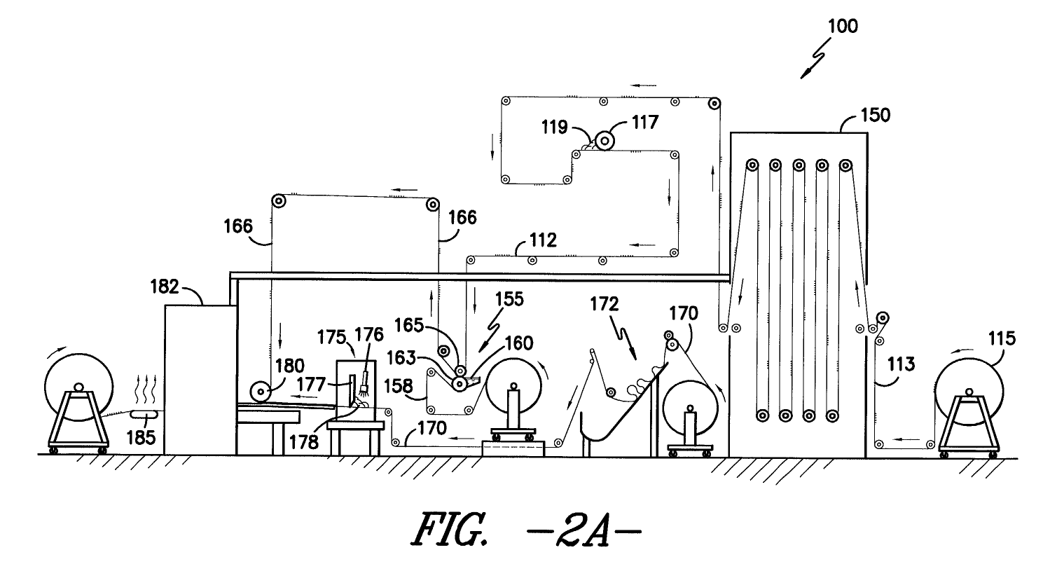

A schematic view illustrating an exemplary apparatus and process used in forming the low weight, cushioned surface covering, wall covering, flooring, floor covering, carpet or tile of the present invention is illustrated in FIG. 2. The apparatus is designated generally by reference numeral 100. As illustrated, a primary carpet fabric 112 which may incorporate either a tufted or a bonded configuration (with loop and/or cut pile) as described above is drawn from a mounted carpet roll 114. As indicated previously, the primary carpet fabric 112 preferably includes a plurality of pile-forming yarns projecting outwardly from one side of a primary backing or base.

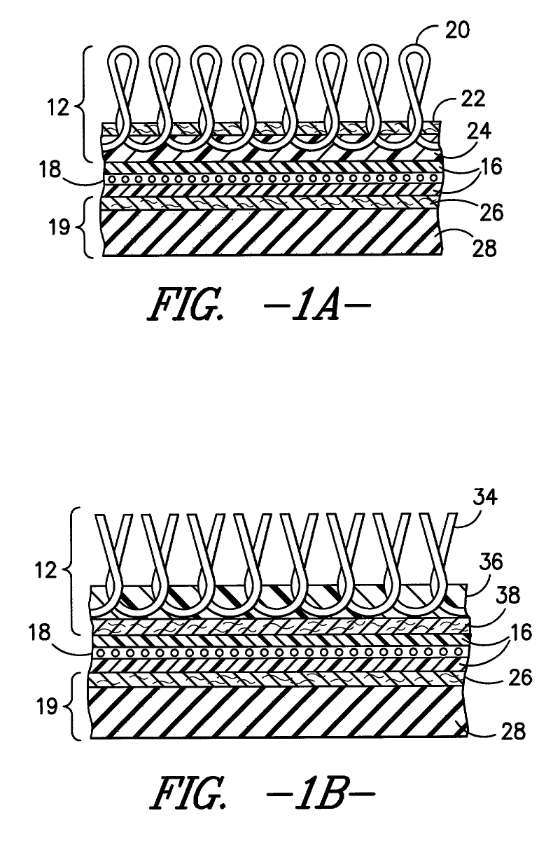

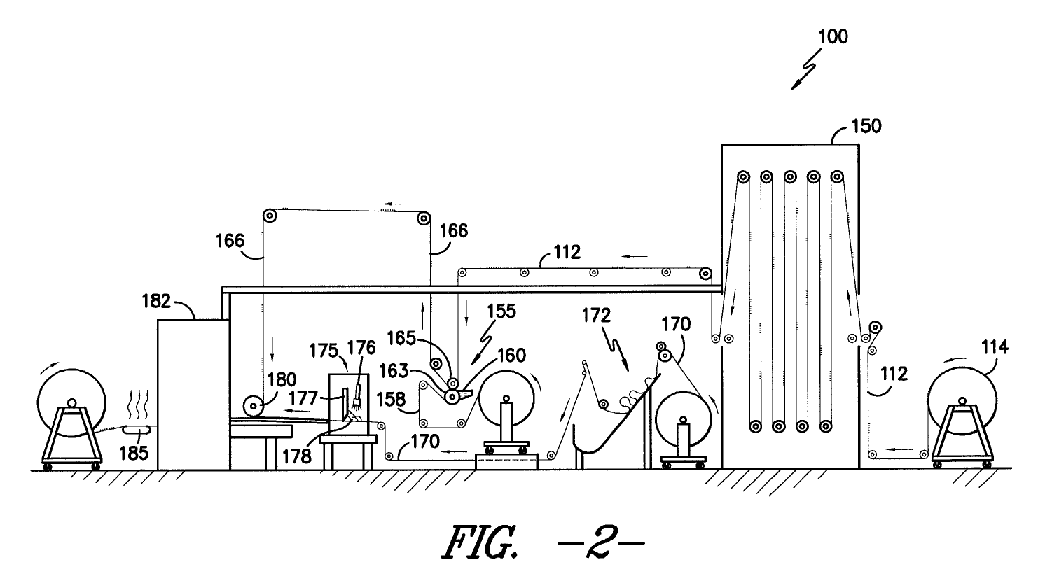

If the primary carpet 112 used in the present invention is a tufted carpet, its configuration will preferably conform to that of the primary carpet 12 illustrated in regard to that in FIG. 1A, while if the primary carpet 112 used in the present invention is a bonded product, its configuration will be that of the primary carpet 12 illustrated in FIG. 1B. It is contemplated that the primary carpet 112 may include one or more backing or base layers.

It is to be understood that, as with the prior art products, wherein the primary tufted or bonded carpet fabric 12 may have different embodiments, the component structure of the primary carpet fabric is not critical to the present invention. Rather it is intended that any low weight (low face weight) primary carpet fabric having a pile forming portion and a primary base may be utilized as the primary carpet fabric. By “primary base” is meant any single layer or composite structure including, inter alia, the commonly used layered composite of primary backing 22 and latex pre-coat 24 previously described in relation to the tufted product (FIG. 1A) and the adhesive layer 36 with reinforcement substrate 38 previously described in relation to the bonded product (FIG. 1B). As will be appreciated, the use of polyester in the primary base structure may be desirable due to the eventual heat curing such structure may undergo. Other embodiments as may occur to those of skill in the art may, of course, also be utilized. For example, in the bonded product, the pile forming yarns could be heat tacked to the substrate 38 as described in U.S. Pat. No. 5,443,881 (hereby incorporated by reference herein) to permit simplified construction of a primary carpet.

Alternative embodiments including those disclosed in U.S. Pat. No. 4,576,665 to Machell (incorporated by reference) may likewise be utilized. For example, it is contemplated that specialized primary backings such as non-woven structures comprising fiberglass sandwiched between layers of polyester may be utilized in the primary tufted carpet to impart the desired properties relating to stability thereby potentially reducing or even eliminating the need for the secondary backing or the latex pre-coat presently utilized. Moreover, it is contemplated that if a pre-coat is to be utilized, it may be added directly in-line in an operation prior to any adhesive operation.

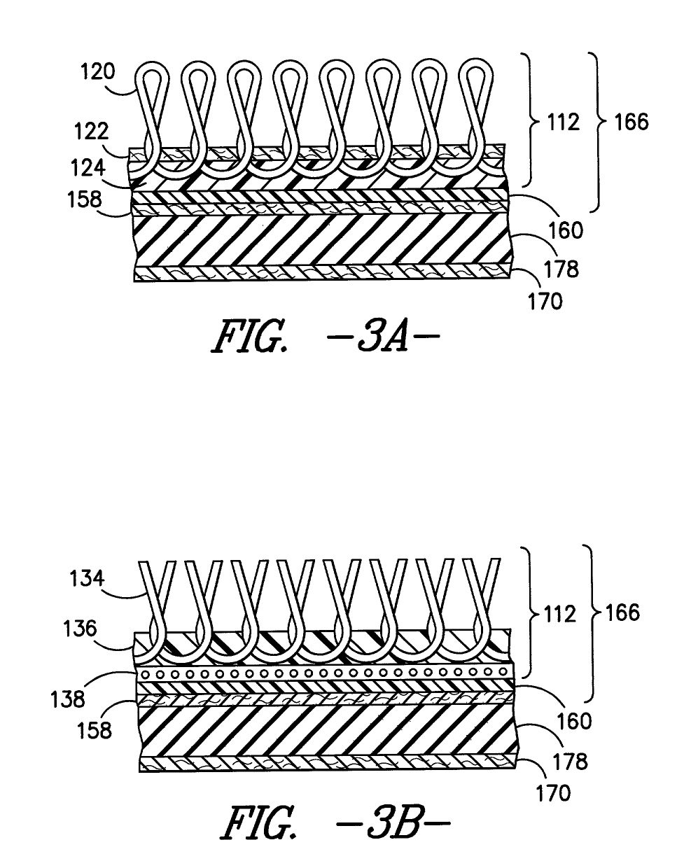

With regard to one embodiment, in the tufted carpet of the present invention (FIG. 3A), the primary carpet fabric 112 preferably comprises a loop pile layer 120 of pile-forming yarns tufted into a primary backing 122 as is well known and held in place by a pre-coat of adhesive 124 such as latex or a hot melt adhesive. It is contemplated that the latex or hot melt adhesive may be added in-line after removal from the carpet roll prior to the application of any other adhesive as described below. The carpet may be steamed after addition of the pre-coat to facilitate subsequent printing operations if desired to reduce stresses. The two basic primary backing constructions are woven polypropylene and non-woven polyester. Each material may have a variety of construction characteristics engineered for a specific end use. The preferred primary backing material is 20 pick per inch, woven polypropylene, with needle punched nylon fleece.

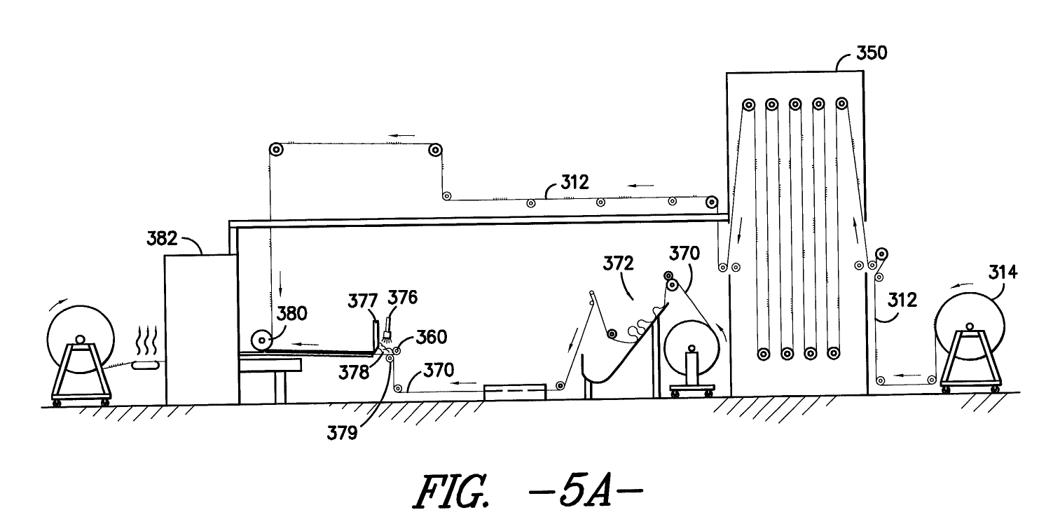

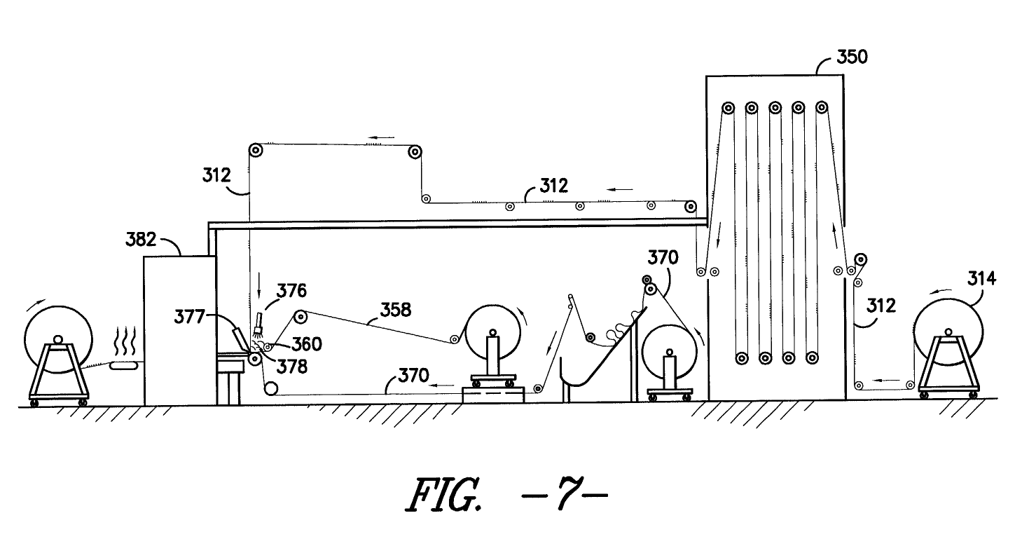

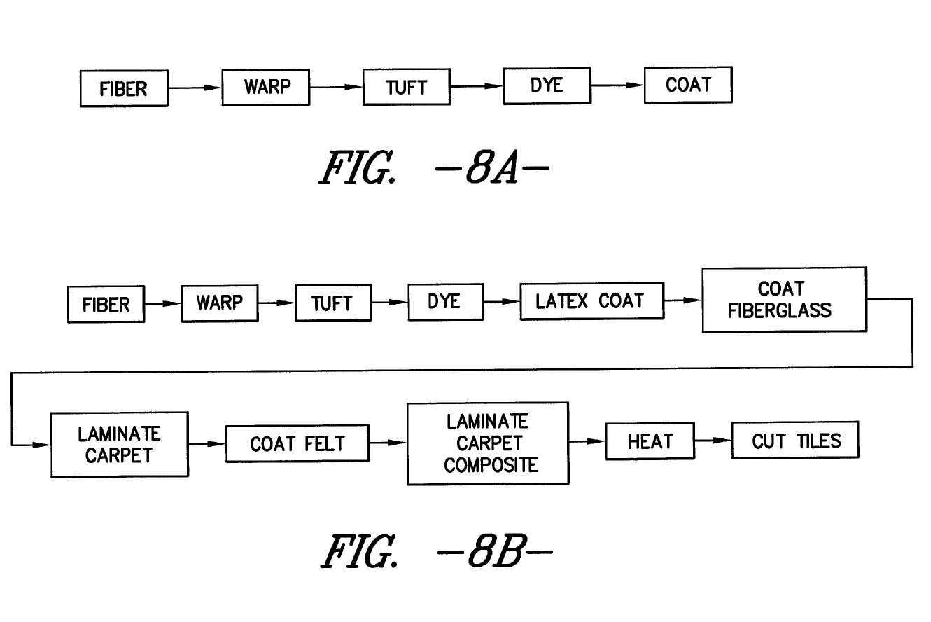

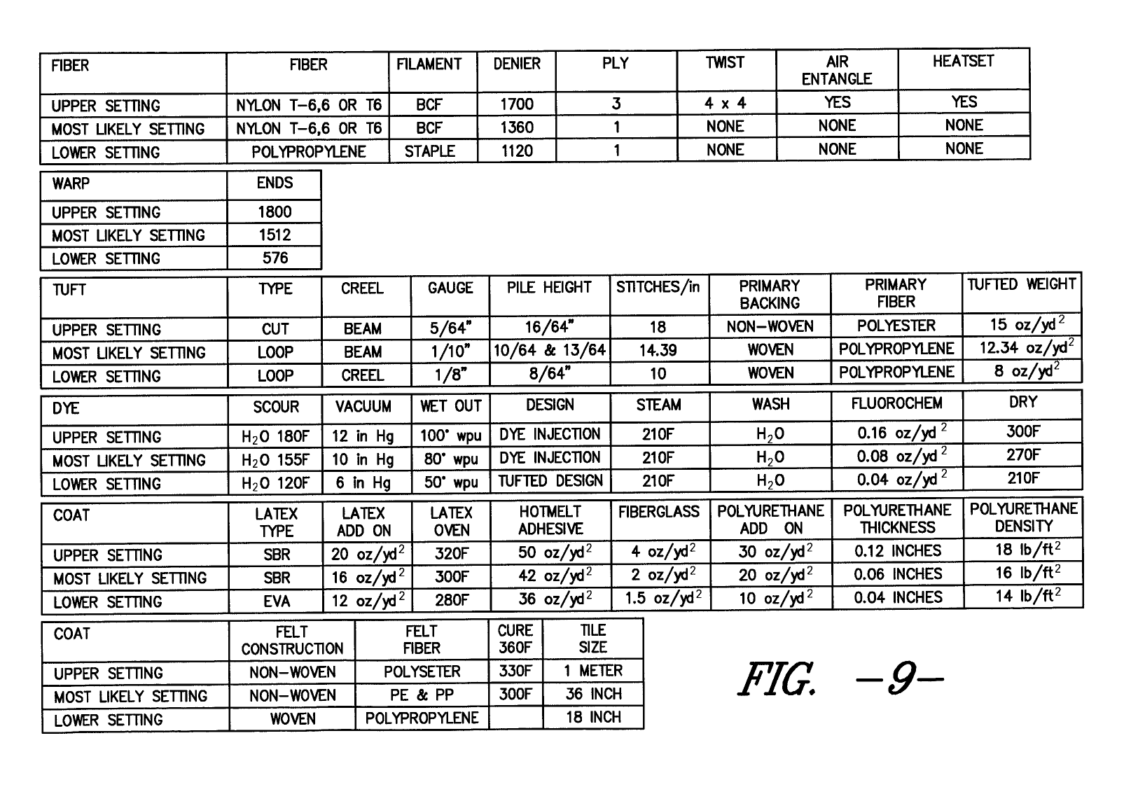

In accordance with one example of the present invention, the primary carpet 112 is a loop pile tufted carpet formed by tufting a non-heatset yarn through the primary backing, then washing, steaming, drying, and injection dyeing to form, preferably, a monolithic or orientation independent design, color, or pattern thereon to form, for example, a 12 foot wide primary carpet precursor of loop pile 120 and primary backing 122. By using non-heatset yarn, and originally tufting the yarn at a rather long loop length, the washing, steaming, drying and dying steps shrink the yarn to form smaller, tighter loops and provide a denser surface to the primary carpet precursor. Next, this primary carpet precursor is split in half and rolled to form, two separate six foot wide rolls of split primary carpet precursor. Next, one roll of the split primary carpet precursor is used as carpet 114 in the apparatus of FIGS. 2 or carpet 314 in FIG. 5 or 7. The latex pre-coat or hot melt adhesive coat 124 is added to the back of the primary carpet precursor to form a primary carpet fabric 112 in the upper run of the apparatus of FIG. 2 downstream of the accumulator 150 and upstream of the reinforcement bonding unit 155. For example, a thin layer of latex pre-coat is applied to the back of the primary carpet precursor using a coating roller.

In accordance with one embodiment of the present invention, the primary carpet precursor (not having a latex pre-coat) is rolled or wound with the primary backing 122 exposed.

Also, it is contemplated that the apparatus and process of the present invention may include the entire assembly process from tufting the yarn in the primary backing, dying the tufted yarn, latex pre-coating the back of the primary backing, hot-melt coating the fiberglass reinforcing material, foam coating the felt secondary backing, laminating the primary carpet, reinforcing fiberglass, and foam cushioning layer, heating or curing the laminate, and cutting the carpet composite into carpet tiles, runners, area rugs, or the like. Also, it is contemplated that in accordance with the present invention the process may be broken down into its respective steps and done in a batch rather than a continuous mode, although the continuous mode of operation is preferred. For example, the primary carpet may be formed in one operation and placed on rolls. The cushion backing or foam layer may be formed in a separate operation and be placed on a roll. The two may be joined by a mating unit using an adhesive, hot melt, hot melt with reinforcing layer, or the like.

In the bonded carpet of the present invention (FIG. 3B), the primary carpet fabric 112 preferably comprises a plurality of cut pile yarns 134 implanted in an adhesive 136 such as a latex or hot melt adhesive which is laminated to a reinforcement or substrate layer 138 of a woven or non-woven material including fiberglass, nylon, polyester, or polypropylene. It is contemplated that this substrate layer 138 may be pre-coated with latex or other thermoplastic polymers to permit melting adhesion with the cut pile yarns 134 upon the application of heat, thereby potentially reducing or eliminating the need for the latex or hot melt adhesive 136.

The yarns 120, 134 may be either spun or filament yarns and are preferably formed from a polyamide polymer such as nylon 6 staple, nylon 6 filament, or nylon 6,6 staple, nylon 6,6 filament, available from DuPont Fibers in Wilmington, Del., although other suitable natural or synthetic yarns may likewise be employed as will be recognized by those of skill in the art. By way of example only and not limitation, other materials, which might be used, include polyester staple or filament such as polyethylene terephthalate (PET), and polybutylene terephthalate (PBT); polyolefins, such as polyethylene and polypropylene staple or filament; rayon; and polyvinyl polymers such as polyacrylonitrile, wool, nylon/wood blends, Lyocell, rayon, saran, acetate, glass, aramid, fluorocarbon, Sulfar, acrylic, Pelco, olefin, melamine, polybenzimidazole, and combinations thereof. A variety of deniers, plies, twist levels, air entanglement, and heatset characteristics can be used to construct the yarn. The preferred yarn is nylon 6,6, filament, 1360 denier, 1 ply, no twist, no entanglement, and no heatset. Another yarn is nylon 6,6, filament, 1350 denier, no ply, nominal twist (0-1 twist), non-heat set.

In the tufted product, the adhesive pre-coat 124 is preferably styrene butadiene rubber (SBR) latex but other suitable materials such as polyvinyl chloride (PVC), ethylene vinyl acetate (EVA), polyurethane, acrylic, and hot melt adhesives as are well known to those of skill in the art may likewise be utilized. In the event that a hot melt adhesive is utilized, it is contemplated that a reinforcement material such as a glass scrim could be directly attached to form a composite laminate without the use of adhesives. Moreover, as previously indicated, it is contemplated that the adhesive pre-coat 124 may be entirely eliminated in the tufted product if the loop pile 120 is tufted in suitably stable relation to the primary backing 122. The commonly used hot melts are bitumen, polyolefin-based thermoplastic, and polyurethane. The preferred hot melt material is polyolefin based thermoplastic.

Referring again to FIG. 2, in the potentially preferred practice the primary carpet fabric 112 is conveyed by means of a plurality of rolls through an accumulator 150 as is well known in the art to a reinforcement bonding unit 155. Simultaneously with the conveyance of the primary carpet fabric 112 to the reinforcement bonding unit 155, a sheet of reinforcement material 158 is likewise conveyed to the reinforcement bonding unit 155. The reinforcement material 158 is preferably fiberglass non-woven material such as a 2.0 oz/yd² fiberglass mat or tissue containing a urea formaldehyde binder although alternative materials may include woven glass, woven polyester, and non-woven polyester.

At the reinforcement bonding unit 155, an adhesive 160 (FIGS. 3A, 3B) such as a hot melt adhesive is preferably applied to the reinforcement material 158 by means of a film coater or other such unit as are well known. The reinforcement material 158 and the primary carpet fabric 112 are thereafter preferably passed in mating relation between joining members such as rolls 163, 165, thereby bonding the reinforcement material 158 to the underside of the primary carpet fabric 112. That is, the reinforcement material 158 is bonded on the side of the primary carpet fabric 112 from which the pile forming yarns do not project. The bonding of the reinforcement material 158 to the underside of the primary carpet fabric 112 produces a preliminary composite 166 which is thereafter laid into a puddle of polymer or foam forming composition such as a polyurethane-forming composition as described below.

Although the reinforcement bonding unit 155 is illustrated in its preferred embodiment as incorporating a film coater, it is to be understood that alternative equivalent means such as application rolls, spray headers and the like may also be utilized. By way of example only, and not limitation alternative means for the application of adhesive 160 are disclosed in U.S. Pat. No. 4,576,665 to Machell.

In the preferred practice, while the preliminary composite 166 is being formed, a backing material 170 such as a non-woven backing is passed through a scray 172 to a polymer application unit 175 which preferably includes a polymer discharge unit 176 and a doctor blade 177. The backing material 170 is coated with a polymer 178 such as a polyurethane-forming composition as disclosed more fully below.

In the preferred embodiment, the backing material 170 is woven or non-woven synthetic fiber material such as 10% to 100% polyester/polypropylene, preferably 50% polyester, 50% polypropylene non-woven fibrous material which is available from Spartan Mills Company in Spartanburg, S.C. While this represents the backing material of preference, it is to be understood that any number of alternative compositions may likewise be utilized as dictated by requirements regarding shrinkage and installation. The commonly used secondary backing materials include non-woven polyester, non-woven polyester and polypropylene blends, or woven polypropylene. By way of example only, in instances where very little or no shrinkage may be tolerated, the backing material may be up to 100% polyester. Further, while a non-woven backing material may be preferred, it is contemplated that either woven or non-woven constructions may be utilized as can materials other than polyester, polypropylene, and polyester/polypropylene such as nylon, fiberglass and the like. The thickness of the backing material 170 preferably varies in the range of from about 0.01 inches to about 0.19 inches, although a range of between about 0.05 inches and 0.12 inches may be most preferred.

As indicated, in the preferred practice, the polymer application unit 175 applies a deposit of a polymer 178 (FIGS. 3A, 3B) to the backing material 170 after which the height of the polymer is doctored to a desired level.

In the preferred practice, the polymer applied is a polyurethane-forming composition based on a so-called soft segment pre-polymer of MDI (diphenylmethane diisocyanate) or an MDI derivative. The polyurethane-forming composition also preferably incorporates a silicone surfactant to improve both the frothability and stability of the polyurethane layer or “puddle” which is spread across the surface of the backing material 170. The commonly used foam density is 18 lbs. per cubic foot with a thickness of greater than 0.10 inches. The preferred density is 16 lbs. per cubic foot with a thickness of 0.06 inches.

The preferred polyurethane-forming composition for use in the present invention is disclosed in U.S. Pat. No. 5,104,693 to Jenkines the teachings of which are incorporated herein by reference. Specifically, the preferred polyurethane-forming composition which is applied across the surface of the carrier backing 170 includes:

A. At least one isocyanate-reactive material having an average equivalent weight of about 1000 to about 5000;

B. An effective amount of blowing agent; and

C. A polyisocyanate in an amount to provide an isocyanate index of between about 90 and about 130, wherein at least 30 percent by weight of such polyisocyanate is a soft segment pre-polymer reaction product of a stoichiometric excess of diphenylmethane diisocyanate (MDI) or a derivative thereof and an isocyanate-reactive organic polymer having an equivalent weight of from about 500 to about 5,000 and wherein the prepolymer has an NCO content of about 10 to about 30 percent by weight.

The polyurethane-forming composition also preferably contains a silicone surfactant to improve frothability and stability in the form of an Organo-silicone polymer such as are disclosed generally in U.S. Pat. No. 4,022,941 to Prokai et al. the teachings of which are incorporated herein by reference. Specifically, the preferred surfactant is preferably a linear siloxane-polyoxyalkylene (AB) block copolymer and specifically a polyalkyleneoxidemethylsiloxane copolymer. One such silicone surfactant which is particularly useful is available under the trade designation L-5614 from OSI Specialties, Inc. whose business address is believed to be 6525 Corners Parkway, Suite 311, Norcross, Ga. 30092.

A sufficient level of the silicone surfactant is used to stabilize the cells of the foaming reaction mixture until curing occurs to allow the preliminary composite 166 to be laid into the uncured polyurethane-forming composition puddle without destabilizing the layer of such polyurethane-forming composition disposed across the surface of the backing material 170. In general, the silicone surfactants are preferably used in amounts ranging from about 0.01 to about 2 parts per hundred parts by weight of component (A) and more preferably from about 0.35 parts to about 1.0 parts by weight of component (A) and most preferably from about 0.4 to 0.75 parts per hundred parts by weight of component (A).

As previously indicated, after disposition of the polymer across the backing material 170 the layer or “puddle” of polymer deposited is preferably doctored to a predetermined height by means of a doctor blade located at the polymer application unit 175. While a simple mechanical doctor blade is preferred, alternative equivalent means such as an air knife or the like may also be used. Such an air knife is disclosed, for example, in U.S. Pat. No. 4,512,831 to Tillotson (hereby incorporated by reference herein).

In one embodiment of the present invention, the primary carpet fabric 112 which is preferably joined to reinforcement material 158 to form the preliminary composite 166 is laid directly into the polyurethane-forming composition immediately after it is doctored to the appropriate level without any need to significantly heat either the preliminary composite 166 or the polyurethane-forming composition. Accordingly, the preliminary composite 166 and the backing material 170 with the applied polyurethane-forming composition may be simultaneously delivered at room temperature to a mating roll 180 immediately following the application and doctoring of the polyurethane-forming composition. As will be appreciated, this avoidance of lag time between formation of the components of the cushioned carpet composite permits highly efficient processing readily controllable either manually or by computer control means (not shown) as are well known to those of skill in the art. In the preferred process, the preliminary composite 166 may be slightly preheated to improve operating control during lamination and curing but such preheat is not essential to formation of the desired product.

In the illustrated and preferred embodiment of the carpet, the process described above results in the layer of reinforcement material 158 being laid adjacent to and at least partially embedded in the layer of polyurethane 178. That is, the reinforcement material 158 is preferably in intimate contact with the polyurethane 178 such that the polymer material is bonded to the reinforcement material and will hold the reinforcement in place.

Once the preliminary composite 166 has been laid into the polyurethane-forming composition, the resulting composite may be heated in a heating unit 182 by means of conduction, radiant, or convection heaters as are well known in the art. Contact conduction heaters may be preferred.

Such heating may be carried out at a temperature of between about 250° F. and about 325° F. for between about 2 minutes and 8 minutes. The resulting cured foam or foam cushion layer (FIGS. 3A, 3B) which is produced thereby has a density of between about 12 pounds per cubic foot and about 20 pounds per cubit foot preferably between about 14 pounds per cubic foot and about 16 pounds per cubic foot, and more preferably about 16 pounds per cubic foot.

Following the heat curing operation, the cushioned carpet composite which is formed may be passed over a unidirectional heat source 185 such as a plate heater or roll heater at about 400° F. to fuse any outstanding fibers on the backing material 170 into a sooth surface. The carpet composite, which is formed, will thereafter be rolled, cut, sliced, or the like. When making carpet tiles, it is preferred that it be cut into carpet tiles almost immediately (rather than rolled) to avoid any undesired cupping or curl. After the carpet tiles are cut from the composite, they are stacked, packaged and stored or shipped to the customer or store.

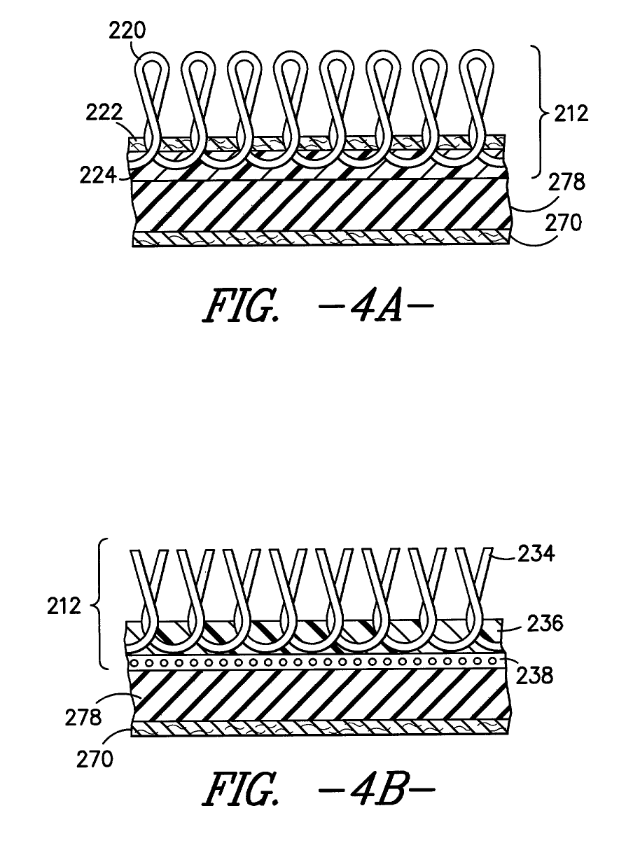

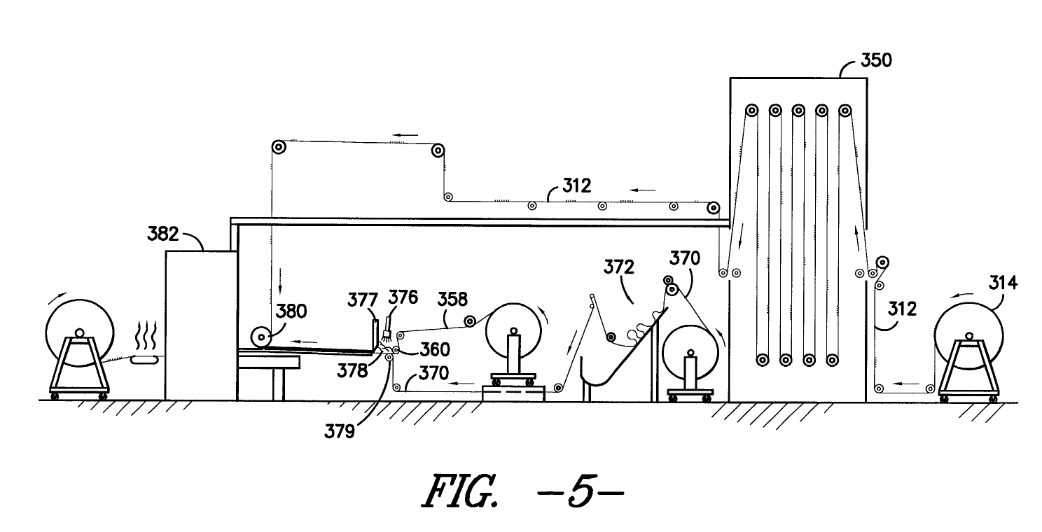

It will be appreciated that a number of alternative practices may be incorporated into the present invention yielding slightly different products. By way of example only, the reinforcement material 158 may be left completely out of the process thereby making the use of the adhesive application apparatus 155 and adhesive 160 completely unnecessary. In such instances, the primary carpet fabric may be laid directly into the polyurethane-forming composition thereby yielding a composite structure as illustrated in FIGS. 4A and 4B with the polyurethane 278 immediately adjacent to the primary carpet fabric 212 and as described in U.S. Pat. No. 6,203,881 hereby incorporated by reference.

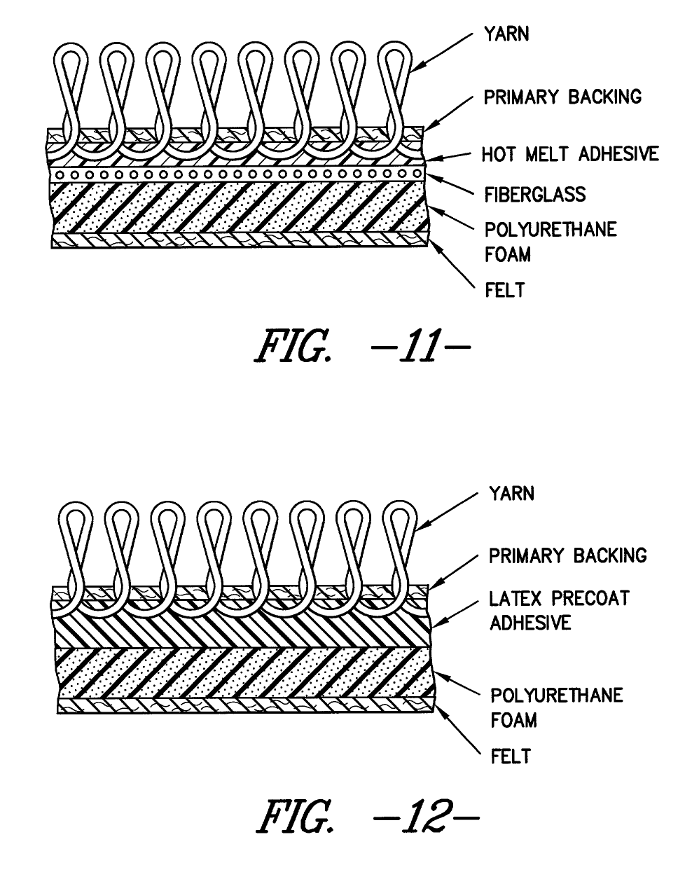

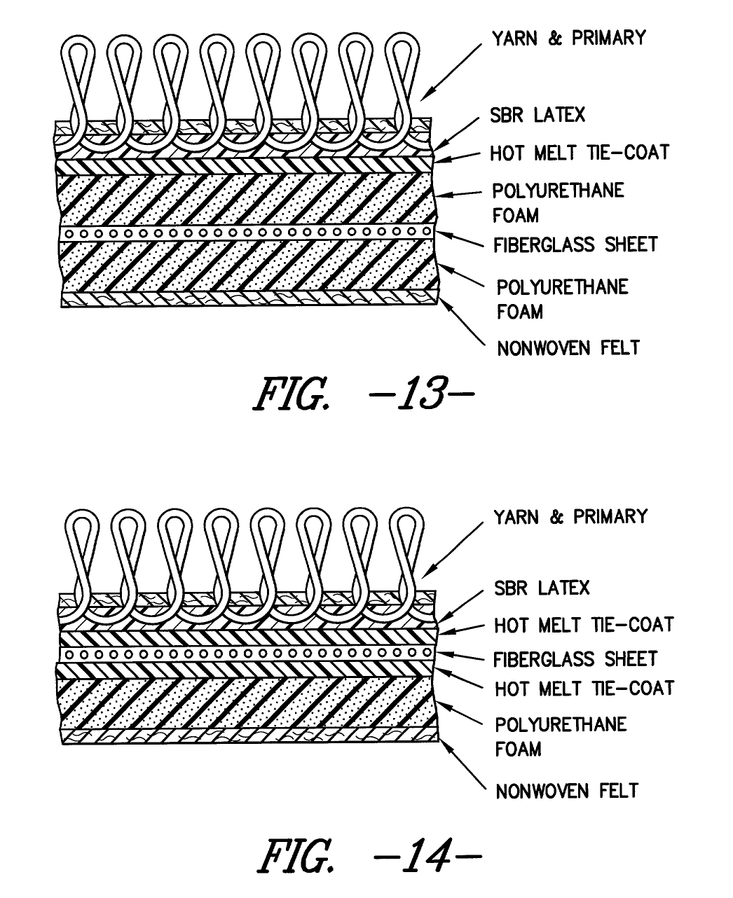

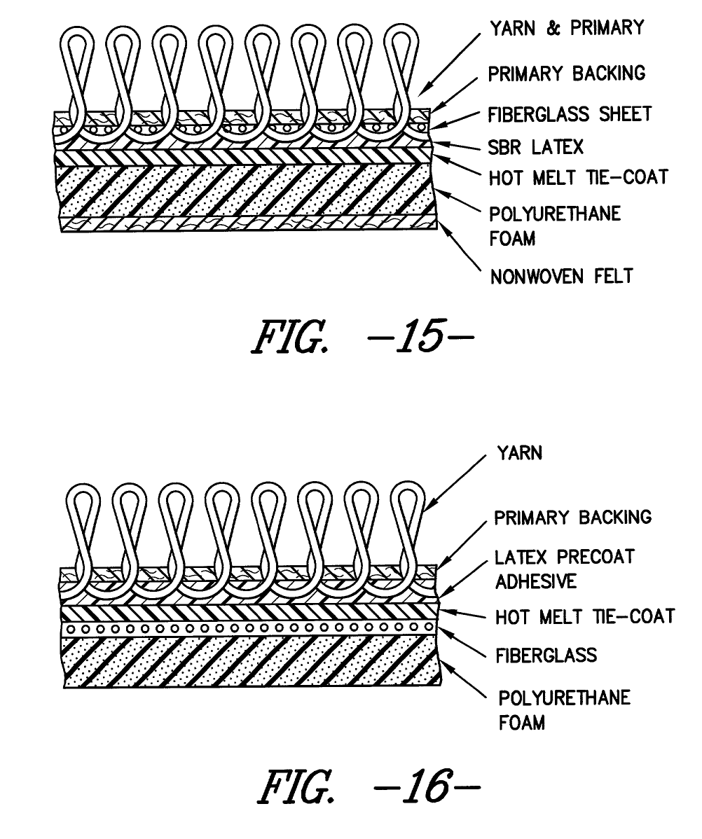

In accordance with another embodiment, when the cushion layer is preformed rather than formed in-situ, a hot melt layer may be used to mate the primary carpet to the cushion layer with or without the reinforcement material (FIG. 12). Such a process described in U.S. Pat. No. 4,522,857 hereby incorporated by reference.

In yet another potential alternative, the backing 170, 270 may have an adhesive quick release backing attached to the face to which the polyurethane-forming composition is not applied. As will be appreciated, such a quick release backing will permit the carpet to be readily installed and removed without damaging the polyurethane cushion 178, 278. Moreover, it is contemplated that in some instances the backing 170, 270 might be completely eliminated such that the polyurethane cushion 178, 278 would directly contact the flooring as disclosed in relation to U.S. Pat. No. 4,286,003 which is incorporated herein by reference. Also, an adhesive-free carpet and method is described for example in co-pending U.S. patent application Ser. No. 09/513,020, filed Feb. 25, 2000, and entitled Adhesive-Free Carpet Tiles and Carpet Tile Installations (hereby incorporated by reference herein). It is preferred that carpet tiles for adhesive-free installations have a cup of about 3/16 inch or less and a curl of 1/16 inch or less.

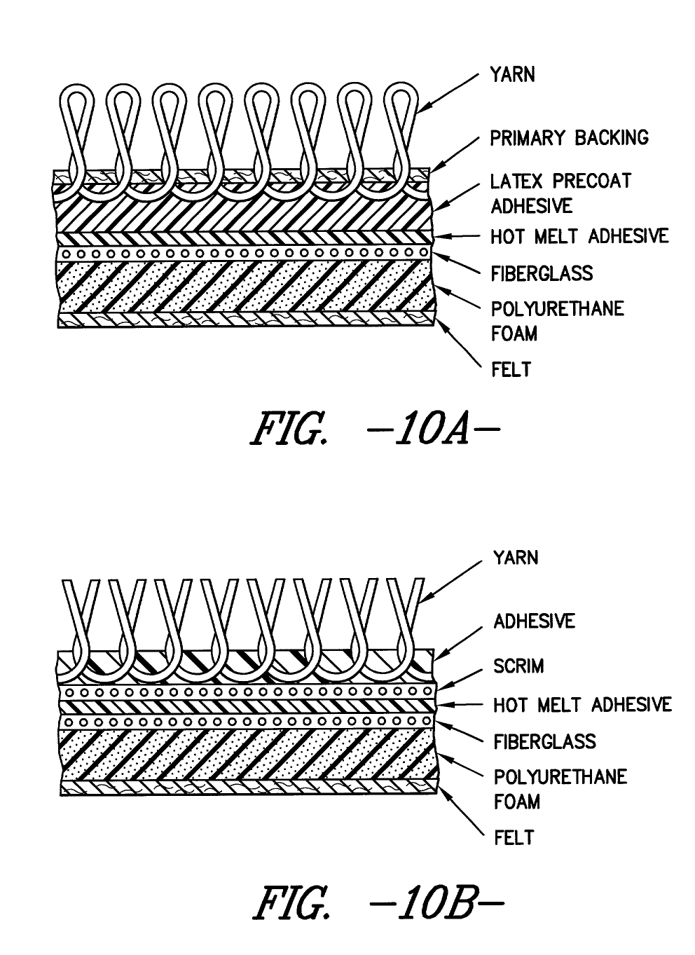

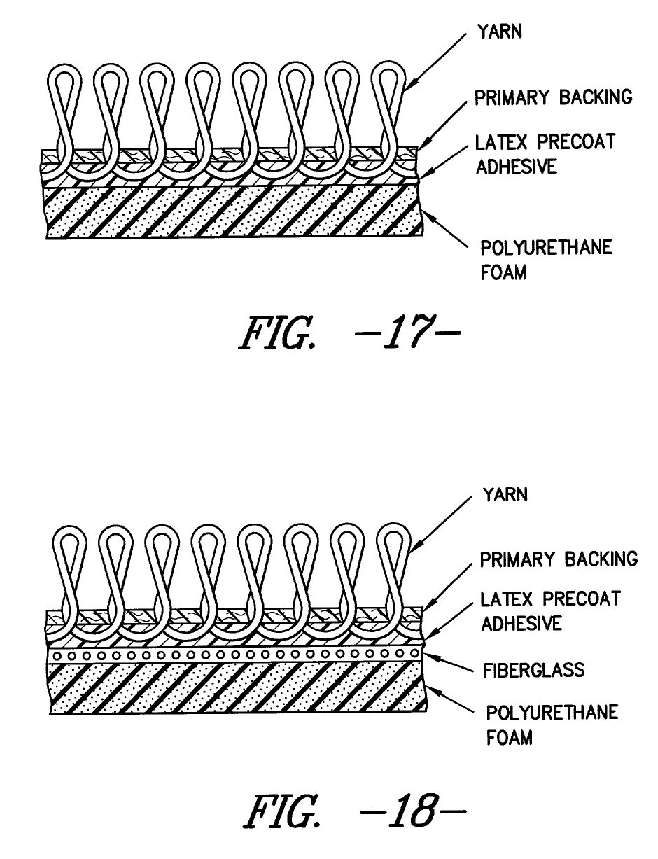

Although it is preferred for the tufted surface covering, tufted low weight modular carpet or low weight modular carpet tile of the present invention to have the following layers: yarn, primary backing, latex pre-coat adhesive, hot melt adhesive, fiberglass, polyurethane foam, and felt (FIG. 10A), it is contemplated that one or more of these layers may be eliminated or substituted for and still provide a low weight carpet or tile having the desired properties or characteristics. For example, the latex pre-coat adhesive layer may be replaced by a bitumen hot melt layer (FIG. 11), the felt layer may be eliminated on a free lay (no floor adhesive) installation product (FIG. 16), the glass layer may be eliminated (FIG. 12), or the like.

An alternative process and apparatus for producing a cushioned carpet composite according to the present invention is shown schematically in FIG. 5. As illustrated, a primary carpet fabric 312 having either a tufted or a bonded configuration is drawn from a mounted carpet roll 314, through an accumulator 350, in the same manner described above. Simultaneously with the delivery of the primary carpet fabric 312 to the mating roll 380, a reinforcement material 358 such as a non-woven glass is delivered to a polymer contact roll 360 or similar device such as an extrusion coater. The polymer contact roll 360 preferably is in rolling contact with both the surface of the reinforcement material 358 as well as with an accumulation of a polymer 378 such as the polyurethane-forming composition previously described. The polymer contact roll 360 serves to pick up a portion of the polymer 378 and to pass the polymer over and through the reinforcement material 358.

Simultaneously with the passage of polymer through the reinforcement material 358, a backing material 370 such as the non-woven polyester/polypropylene described above is preferably passed in adjacent mating relation to the polymer-coated reinforcement material 358 between the polymer contact roll 360 and a backing material mating roll 379. A doctor blade 377 serves to control the depth of the polymer which does not pass through the reinforcement material 358 into contact with the backing material 370. Thus, it is to be appreciated that a polymer sandwich structure is formed preferably comprising a layer of backing material 370, a relatively thin layer of polymer 378 such as polyurethane which has been passed through a layer of reinforcement material 358, and a doctored layer of polyurethane 378 which was not passed through the reinforcement material 358. This polymer sandwich structure can thereafter be passed to the mating roll 380 for joinder with the primary carpet fabric 312 by laying the primary carpet fabric 312 directly into the doctored layer of polyurethane 378 without any pre-curing operation. Thereafter, the composite is heated, cured, and rolled or cut.

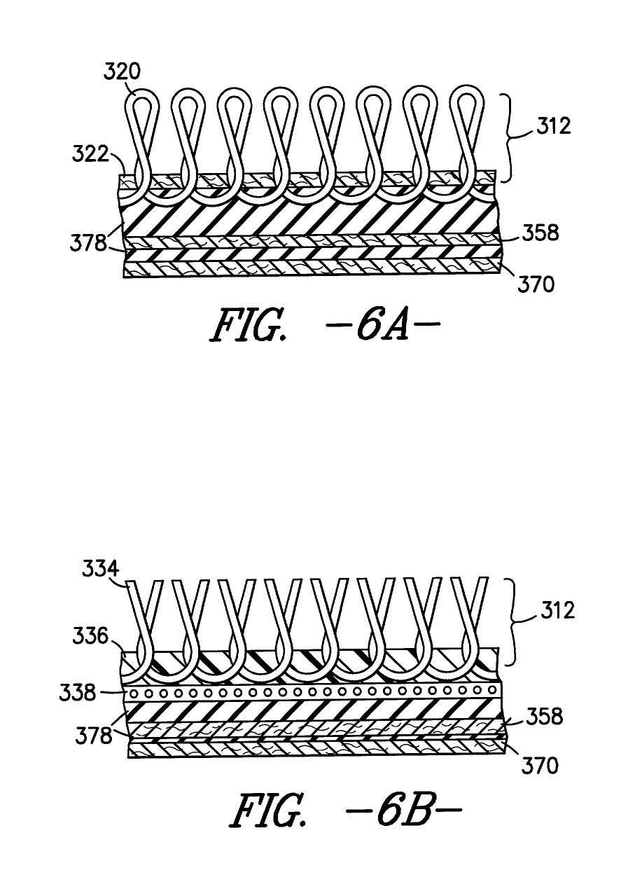

A potentially preferred configuration for a resulting tufted carpet composite is illustrated in FIG. 6A. As illustrated, the reinforcement material 358 will be at least partially surrounded by, and embedded in, the polyurethane 378. As illustrated, it is contemplated that the layer of pre-coat may be eliminated in the tufted structure since the tufts may be held in place by the polyurethane 378. A potentially preferred configuration for a resulting bonded carpet composite is shown in FIG. 6B.

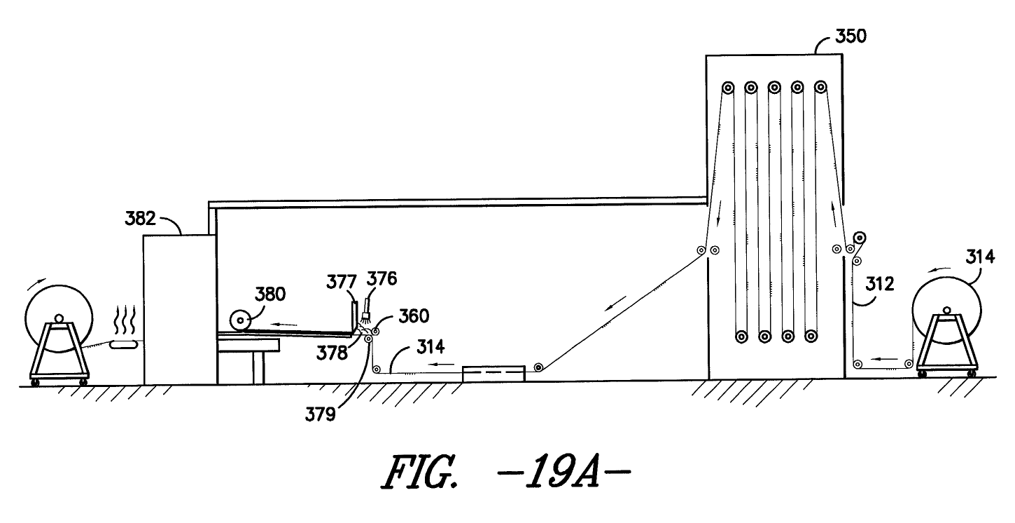

With respect to FIGS. 5A and 18 of the drawings, the reinforcement material and hot melt layers can be eliminated simply by not feeding the reinforcement 358 along with the felt 370 and primary carpet 312.

A further alternative process and apparatus for joining all layers of the cushioned carpet composite is illustrated in FIG. 7. As shown, a layer of reinforcement material 358 is preferably passed adjacent to a polymer contact roll 360 which is in simultaneous rolling contact with both the reinforcement material 358 and a deposit of polymer 378. The polymer contact roll 360 serves to spread a portion of the polymer 378 through the reinforcement material 358 to create a coating on both sides thereof. The reinforcement material 358 with its coating of polymer 378 is then joined in a laminate structure to the primary carpet fabric 312 and a layer of backing material 370 by passage through the nip between the doctor blade 377 and backing material mating roll 379. Thereafter, the composite is heated, cured, and rolled or cut. This practice will yield a bonded carpet composite structure substantially similar to those which are illustrated in FIGS. 6A and 6B.

In accordance with one aspect of the present invention, the designs that are printed on the low weight modular carpet or carpet tile are preferably characterized as orientation independent or as having the ability to seam properly without cutting the tiles in register with the design. The techniques used to create these designs make it possible to install modular carpet monolithically rather than quarter turn or ashler. The commonly used techniques of modular carpet installation such as quarter turn (parquet), monolithic, and ashler (brick) may be used to install low weight carpet or carpet tiles of the present invention. The preferred technique is monolithic or ashier. Also, a floor adhesive may or may not be used depending on whether the carpet or tile is designed for adhesive-free installation or conventional adhesive installation. Also, the carpet tile may be self-stick and contain an adhesive quick release backing attached to the face of the backing 170, 270 opposite the polyurethane foam.

With reference to FIGS. 19 and 19A of the drawings, the felt and hot melt layers can be eliminated by, for example, feeding the primary carpet 314 through an apparatus similar to that shown in FIG. 5 of the drawings, except that the carpet is inverted and the polymer layer or layers are applied directly to the reinforcement material and/or lower surface of the primary carpet.

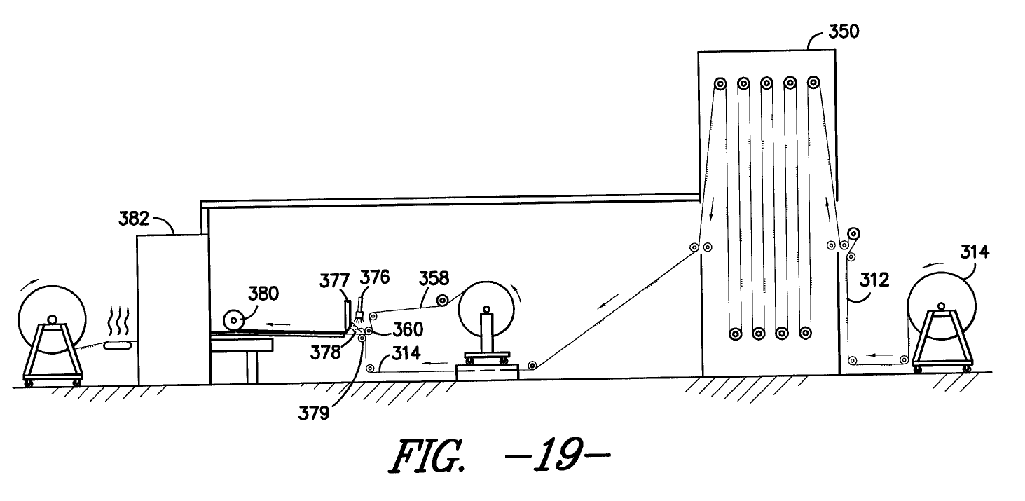

With respect to FIGS. 17 and 19A of the drawings, the reinforcement material such as glass is eliminated by not feeding the reinforcement material along with the carpet and polymer.

In accordance with one example of the present invention, the low weight modular carpet tile of Example I below was tested using a hexapod test as described below.

Test Method Conducted
ASTM D-5252 Hexapod Drum Tester
ISO/TR 10361 Hexapod Tumbler
Ratings Based on CRI TM-101 Photographic Scales

Apparatus: Wira Instrumentation Hexapod Tumbler Carpet Tester

Procedure:

The test specimen was subjected to the reported cycles of “Hexapod” tumbling, removing the specimen every 2,000 cycles for restoration by vacuuming.

An Electrolux upright vacuum cleaner (Discovery II) was used, making four (4) forward and backward passes along the length of the specimen.

The samples were assessed using daylight equivalent vertical lighting (1500 lux). Samples were viewed at an angle of 45 degrees from 1½ meter distance, judging from all directions.

The samples were also measured for pile height before and after testing to obtain a pile height retention value.

TEST RESULTS

| | | | |
|---|---|---|---|
| Number of Hexapod Cycles | 4000 | 12000 | Key to Ratings |
| Color Change | 3-4 | 3 | 5 = Negligible or no |
| | | | change |
| Pile Height Retention | 89.4% | 74.8% | 4 = Slight change |
| Overall Appearance Change | 4 | 3 | 3 = Moderate change |
| | | | 2 = Considerable change |
| | | | 1 = Severe change |

The invention may be further understood by reference to the following examples which are not to be construed as unduly limiting the invention which is to be defined and construed in light of the appended claims.

### EXAMPLE I

A tufted carpet was produced by the apparatus and process as illustrated and described in relation to FIG. 2. The carpet produced has the configuration illustrated and described in relation to FIG. 3A. The production parameters were as follows:

| | |
|---|---|
| Yarn | 15 ounces per sq. yd. nylon 6,6 loop pile |
| | continuous filament |
| Primary Backing | 4 ounces per sq. yd. non-woven polyester |
| Pre-coat | 16 ounces per sq. yd. SBR Latex filled |
| | with 100 parts CaCO.sub.2. |
| Hot Melt Adhesive | 42 ounces per sq. yd. modified polypropylene |
| Laminate | 2 ounces per sq. yd. Non-woven glass with |
| Reinforcement | acrylic binder |
| Urethane Foam Coverage | 20 ounces per sq. yd. |
| Urethane Foam Density | 16 pounds per cubic foot |
| Backing Material | 4 ounces per sq. yd. Non-woven (50% |
| | polypropylene, 50% polyester) |

### EXAMPLE II

| | |
|---|---|
| Construction | Tufted, Textured Loop Pile |
| Face Fiber | 100% Milliken Certified WearOn ® |
| | Nylon |
| Soil Protectant | MilliGuard ® |
| Antimicrobial | BioCare ® |
| Dye Method | Millitron ® Dye Injection Printing |
| Gauge | 1/10 in. (39.4/10 cm.) |
| Rows | 14.4/in. (56.7/10 cm.) |
| Tufts | 143.9/sq.in. (2230.3/100 sq.cm.) |
| Standard Backing | PVC-Free UNDERSCORE ™ cushion |
| Nominal Total Thickness | 0.34 in. (8.6 mm) |
| Total Weight | 99.9 oz./sq.yd. (3,387.4 g./sq.m.) |
| Tile Size | 36 × 36 in. (914.4 × 914.4 mm) |
| Flammability (Radiant Panel | ≧0.45 (Class I) |
| ASTM-E-648) | |
| Smoke Density (NFPA-258-T | ≦450 |
| or ASTM-E-662) | |
| Methenamine Pill Test | Self-Extinguishing |
| (CPSC FF-1-70 or | |
| ASTM D 2859) | |
| Lightfastness (AATCC 16E) | ≧4.0 at 80 hrs. |
| Cracking (AATCC 165) | ≧4.0 wet or dry |
| Static Electricity | ≦3.5 KV |
| (AATCC-134) | |
| 20% R.H., 70° F. | |
| Dimensional Stability- | >0.2% |
| Aachener test | |
| (DIN Standard 54318) | |
| Recommended Traffic | Heavy Commercial |
| Recommended Maintenance | Millicare ® |
| CRI Indoor Air Quality | Product Type: 12200793 |

### EXAMPLE III

| | |
|---|---|
| Construction | Tufted, Textured Loop Pile |
| Face Fiber | 100% Milliken Certified WearOn ® |
| | Nylon |
| Soil Protectant | MilliGuard ® |
| Antimicrobial | BioCare ® |
| Dye Method | Millitron ® |
| Gauge | 1/10 in. (39.4/10 cm.) |
| Rows | 14.4/in. (56.7/10 cm.) |
| Tufts | 143.9/sq.in. (2230.3/100 sq.cm.) |
| Standard Backing | PVC-Free UNDERSCORE ™ cushion |
| Nominal Total Thickness | 0.34 in. (8.6 mm) |
| Total Weight | 99.9 oz./sq.yd. (3,387.4 g./sq.m.) |
| Tile Size | 36 × 36 in. (914.4 × 914.4 mm) |
| Flammability (Radiant Panel | ≧0.45 (Class I) |
| ASTM-E-648) | |
| Smoke Density (NFPA-258-T | ≦450 |
| or ASTM-E-662) | |
| Methenamine Pill Test | Self-Extinguishing |
| (CPSCFF-1-770 or | |
| ASTM D 2859) | |
| Lightfastness (AATCC 16E) | ≧4.0 at 80 hrs. |
| Crocking (AATCC 165) | ≧4.0 wet or dry |
| Static Electricity | ≦3.5 KV |
| (AATCC-134) | |
| 20% R.H., 70° F. | |
| Dimensional Stability- | >0.2% |
| Aachener Test | |
| (DIN Standard 54318) | |
| Recommended Traffic | Heavy Commercial |
| Recommended Maintenance | MilliCare ® |
| CRI Indoor Air Quality | Product Type: 12200793 |

### EXAMPLE IV

A tufted carpet is produced by the apparatus and process as illustrated and described in relation to FIG. 2. The carpet has the configuration illustrated and described in relation to FIG. 3A. The production parameters are as follows:

| | |
|---|---|
| Yarn | 12 ounces per sq. yd. nylon 6,6 loop pile |
| | continuous filament, white, 1350 denier, |
| | not plied, not twisted, not heat set |
| Primary Backing | 4 ounces per sq. yd. non-woven polyester |
| Pre-coat | 16 ounces per sq. yd. SBR Latex filled |
| | with 100 parts CaCO.sub.2. |
| Hot Melt Adhesive | 36 ounces per sq. yd. modified polypropylene |
| Laminate | 2 ounces per sq. yd. Non-woven glass with |
| Reinforcement | acrylic binder |
| Urethane Foam Coverage | 15 ounces per sq. yd. |
| Urethane Foam Density | 16 pounds per cubic foot |
| Backing Material | 4 ounces per sq. yd. Non-woven (50% |
| | polypropylene, 50% polyester) |

### EXAMPLE V

A tufted carpet is produced by the apparatus and process as illustrated and described in relation to FIG. 2. The carpet has the configuration illustrated and described in relation to FIG. 3A. The production parameters are as follows:

| | |
|---|---|
| Yarn | 16 ounces per sq. yd. nylon 6,6 loop pile |
| | continuous filament |
| Primary Backing | 2 ounces per sq. yd. non-woven polyester |
| Pre-coat | 14 ounces per sq. yd. SBR Latex filled |
| | with 100 parts CaCO.sub.2. |
| Hot Melt Adhesive | 38 ounces per sq. yd. modified polypropylene |
| Laminate | 3 ounces per sq. yd. Non-woven glass with |
| Reinforcement | acrylic binder |
| Urethane Foam Coverage | 12 ounces per sq. yd. |
| Urethane Foam Density | 14 pounds per cubic foot |
| Backing Material | 2 ounces per sq. yd. Non-woven (50% |
| | polypropylene, 50% polyester) |

### EXAMPLE VI

A tufted carpet is produced by the apparatus and process as illustrated and described in relation to FIG. 5. The carpet has the configuration illustrated and described in relation to FIG. 6A. The production parameters are as follows:

| | |
|---|---|
| Yarn | 15 ounces per sq. yd. nylon 6,6 loop pile |
| | continuous filament, white, 1350 denier, |
| | not plied, not twisted, not heat set |
| Primary Backing | 4 ounces per sq. yd. non-woven polyester |
| Laminate | 2 ounces per sq. yd. Non-woven glass with |
| Reinforcement | acrylic binder |
| Urethane Foam Coverage | 36 ounces per sq. yd. |
| Urethane Foam Density | 16 pounds per cubic foot |
| Backing Material | 4 ounces per sq. yd. Non-woven (50% |
| | polypropylene, 50% polyester) |

### EXAMPLE VII

A tufted carpet is produced by the apparatus and process as illustrated and described in relation to FIG. 19. The carpet has the configuration illustrated and described in relation to FIG. 18. The production parameters are as follows:

| | |
|---|---|
| Yarn | 15 ounces per sq. yd. nylon 6,6 loop pile |
| | continuous filament, white, 1350 denier, |
| | not plied, not twisted, not heat set |
| Primary Backing | 4 ounces per sq. yd. non-woven polyester |
| Pre-coat | 16 ounces per sq. yd. SBR Latex filled |
| | with 100 parts CaCO.sub.2. |
| Reinforecment | 2 ounces per sq. yd. Non-woven glass with |
| Material | acrylic binder |
| Urethane Foam Coverage | 20 ounces per sq. yd. |
| Urethane Foam Density | 16 pounds per cubic foot |

Comfort Rating

1. Gmax—Gmax simulates footfall onto a surface. The measure is reported as multiples of “g” (gravities), or Gmax. The lower the value, the lower the force upon impact, and the more comfortable underfoot the product feels. The higher the value, the higher the force upon impact, and the less comfortable the carpet feels.

Gmax Test Results

Standard Milliken ComfortPlus® cushion-backed carpet tile—116

Low weight cushion backed carpet tile of the present invention—129

Standard commercial broadloom without underlayment—185

Standard hardback carpet tile, such as Everwher a PVC hardback—227

Resilience Rating

Cushion Resilience—Cushion resiliency measures the rebound percent of a metal ball when dropped from a standard height. It shows the shock absorbing character of the cushion, which helps reduce visible wear of the carpet face. The higher the value, the higher the rebound percent, and the more resilient the cushion.

Resilience Results

Standard Milliken ComfortPlus® cushion backed carpet tile—30

Low weight polyurethane cushion back carpet tile of the present invention—27

Standard commercial broadloom without underlayment—17

Standard hardback carpet tile—13

Appearance Retention

Appearance Retention Rating (ARR)—the ARR value is determined by grading the appearance change of carpet subjected to exposure conditions in accordance with either the ASTM D-5252 (Hexapod) or ASTM D-5417 (Vettennann) test method using the number of cycles for short and long-term tests specified.

ARR—Light (short-term>/=3.0, long-term>/=2.5

ARR—Moderate (short-term>/=3.5, long-term >/=3.0

ARR—Heavy (short-term>/=4.0, long-term >/=3.5

The low weight modular carpet tile of the present invention had an APR of about 4.0 short term and 3.5 long term.

Durability

The low weight polyurethane cushion back carpet tile of the present invention is very durable and can withstand 25,000 cycles or more of the caster chair test without failure.

In accordance with at least one embodiment of the present invention, the low face weight primary carpet preferably has a face weight of less than 15 oz/yd², more preferably 12 oz/yd² or less.

The low weight carpet tile of the present invention is unexpectedly very merchantable and commercially viable due in part to its reduced cost; look, wear, and cushion characteristics; seamability; patterned monolithic design; uniformity of appearance between tiles; constant shade; durability; less crush; short pile; dense surface; and combinations thereof.

One method used to achieve sufficient yarn coverage, suitable for patterning and resilience in commercial use, on the low face weight carpet tile of the present invention is to utilize a singles yarn of sufficient denier, in the range of 1000 d and 1400 d, in a non-heatset form. By using non-heatset yarn, the shrinkage which normally takes place in heatsetting (typically about 11%), now takes place in the wet processing of dyeing the tufted carpet. After dye application, the carpet enters the continuous dye steamer, where the yarn bulks (shrinks ˜11%) in the formed fabric of the carpet, thus dramatically increasing the coverage of the carpet face, lowering the pile height, and making a much denser face fabric. The positive result of this post fabric formation shrinkage is better carpet performance with low density face weight, and improved aesthetic appearance due to the improved coverage.

In accordance with one embodiment of the present invention, it is preferred to have a pile height of less than 8/64 inch after dyeing (after heat set).

In accordance with at least one embodiment of the present invention, it is preferred to use an open cell foam such as a polyurethane foam in the foam or cushion backing.

The lighter weight and reduced thickness of the tiles allows more tiles to be added in each box or on each pallet. Also, each file is easier to handle during installation, easier to cut, and easier to bend.

There are at least four options or examples of the foam cushion to obtain low weight, commercially acceptable foam products using polyurethane.

1) Use of standard filled Polyurethane system. One polyurethane foam contains 10 parts of filler and is applied as low a density as 15 #/cu. ft. If the thickness is in the range of 0.04-0.12 and we determine polymer weight only, using the density and filler levels above, the weight range of the polymer would be 4.32 oz/sq yd to 12.96 oz/sq yd.

2) A second option which would also work would be to increase the filler levels to 190 and reduce the density to 13 #/cu. ft. (Min. which is possible with a filled system). At the same thickness limits the polymer weights would then be 2.72-8.24 oz/sq. yd.

3) A third option would be to use an unfilled polyurethane (Prime urethane) system. High densities such as above are not possible with prime however, they perform because of the wall structure and the fact that no filler is present If we consider a prime to be at 6 #/cu. ft. applied at the thickness limits above the polymer weight would be 2.88-8.64 oz/sq. yd.

4) A fourth option is also possible. Textile Rubber has a polyurethane system available called “Kangahide” which has only 15 parts of a filler material and is applied at 6-9 lb/cu. ft. density, if a polymer calculation is again made at the describe thickness limits it would be 4.3-13.02 oz/sq. yd.

Although the above examples have to do with Polyurethane, a water based foam system can also be used.

Although it is preferred to print the carpet composite and then cut tiles therefrom, the carpet composite may be cut into tiles and then each cut tile may be printed. For example, the cut tiles or blanks may be jet dyed or dye injection printed. This provides for improved design or pattern registration on the tiles and allows for monolithic installation of complex designs.

In one embodiment, the invention relates to a single 1350 d, white carpet yarn that is tufted into a backing. The face weight is usually about 12 ounces/yd². The resulting face fabric is weak, and has many “holes” where the backing is visible through the face. The face is applied to a cushion backing by a hot-melt resilient layer. The carpet is passed through the broadloom Millitron jet dye process, whereby the steam and dry heat involved in the dye fixation process shrink the tuft yarns. The shrinkage results in short, dense tufts that are durable and have good appearance. The roll is then cut into tiles and shipped.

In accordance with at least one embodiment, the low weight cushion backed carpet of the present invention provides for one or more of the following:

Benefits

1. Reduced Cost

2. Underfoot Comfort

3. Performance

Reduced Cost

1. Less raw materials—lower pile height

2. Lower processing cost—lower yarn conversion

a. No heatsetting

b. No twisting

c. No plying

3. Less dye

a. Lower amount

b. Print broadloom and cut

c. 10 gauge

d. Coagulation chemistry—dye concentration at tip

4. No edge trimming required

5. Backing

a. Different backing—polypropylene (woven)

b. Nylon cap (for functionality)

6. Lower foam cost

a. Thinner layer

b. Increased speed down range

7. 36″ tiles (larger tiles)

8. More yardage can be run before doffing

9. Shipping/packaging—from 80 to 110 tiles per pallet (low thickness/light weight)

10. Installation

a. Can use brick-laying pattern (lots of patterns)

b. Easier to cut and lift because it is thinner

Performance Benefits

1. Long lasting

a. Appearance retention

b. Foam resilience retention

c. Less susceptible to “pulled lines”

2. Highly patterned

3. Vacuums more easily

4. Can use an ashler pattern for laying the tiles—fewer visible seams

5. Performance

a. Under-foot comfort

b. Resilience/durability improved in high traffic areas

C. Crush resistance

d. Ergonomics

e. Noise reduction

f. Hides imperfections under carpet

g. Roll resistance reduced

h. Tuft binding

It is, of course, to be appreciated that while several potentially preferred embodiments have been shown and described, the invention is in no way to be limited thereto, since modifications may be made and other embodiments of the principles of this invention will occur to those skilled in the art to which this invention pertains. Therefore, it is contemplated by the appended claims to cover any such modifications and other embodiments as incorporate the features of this invention within the true spirit and scope thereof.

1. A surface covering, wall covering, flooring, carpet, or carpet tile, comprising a low face weight primary carpet and a cushion layer.

2. The surface covering, wall covering, flooring, carpet, or carpet tile as recited in claim 1, wherein the low face weight is less than or equal to about 15 oz/yd².

3. The surface covering, wall covering, flooring, carpet, or carpet tile as recited in claim 1, further comprising an adhesive layer between said primary carpet and said cushion layer.

4. The surface covering, wall covering, flooring, carpet, or carpet tile as recited in claim 3, wherein the adhesive layer is less than or equal to about 50 oz/yd².

5. The surface covering, wall covering, flooring, carpet or carpet tile as recited in claim 4, wherein the adhesive layer is about 36-50 oz/yd .

6. The surface covering, wall covering, flooring, carpet, or carpet tile as recited in claim 3, further comprising a reinforcing material.

7. The surface covering, wall covering, flooring, carpet, or carpet tile as recited in claim 1, wherein the cushion layer is about 0.04-0.12 inches thick.

8. The surface covering, wall covering, flooring, carpet, or carpet tile as recited in claim 7, wherein said cushion layer is about 0.04-0.09 inches thick.

9. The surface covering, wall covering, flooring, carpet, or carpet tile as recited in claim 1, wherein the cushion layer has a polymer weight of less than about 15 oz/yd².

10. The surface covering, wall covering, flooring, carpet, or carpet tile as recited in claim 9, wherein said cushion layer has a polymer weight of about 4.32-12.96 oz/yd².

11. The surface covering, wall covering, flooring, carpet or carpet tile as recited in claim 10, wherein said cushion layer includes a polyurethane foam having about 110 parts of filler by weight.

12. The surface covering, wall covering, flooring, carpet, or carpet tile as recited in claim 1, wherein the cushion layer has a polymer weight of about 2.72-8.24 oz/yd².

13. The surface covering, wall covering, flooring, carpet, or carpet tile as recited in claim 12, wherein said cushion layer includes a polyurethane foam with about 190 parts of filler by weight.

14. The surface covering, wall covering, flooring, carpet, or carpet tile as recited in claim 1, wherein the cushion is an unfilled polyurethane.

15. The surface covering, wall covering, flooring, carpet, and carpet tile as recited in claim 14, wherein said cushion layer has a density of about 6 lbs./per cubic foot and a polymer weight of about 2.88-8.64 oz/yd².

16. The surface covering, wall covering, flooring, carpet, or carpet tile as recited in claim 1, wherein the cushion layer includes a lightweight cushion having a density of about 6-9 lb./cu. ft.

17. The surface covering, wall covering, flooring, carpet, or carpet tile as restricted in claim 16, wherein said lightweight cushion is a polyurethane system with about 15 parts of filler material by weight and a polymer weight of about 4.30-13.02 oz/yd².

18. The surface covering, wall covering, flooring, carpet, or carpet tile as recited in claim 1, wherein said cushion layer includes at least one of a polyurethane foam and a water based foam system.

19. The surface covering, wall covering, flooring, carpet, or carpet tile as recited in claim 1, wherein the cushion layer includes a lightweight cushion having a density of 16 lbs. per cubic foot.

20. The surface covering, wall covering, flooring, carpet, or carpet tile as recited in claim 1, having resilience and under foot comfort.

21. The surface covering, wall covering, flooring, carpet, or carpet tile as recited in claim 1, exhibiting performance characteristics that rate it for heavy commercial use.

22. The surface covering, wall covering, flooring, carpet, or carpet tile as recited in claim 1, further comprising a reinforcing material embedded in said cushion layer.

23. The surface covering, wall covering, flooring, carpet, or carpet tile as recited in claim 22, wherein said cushion layer is about 0.04-0.12 inches thick.

24. The surface covering, wall covering, flooring, carpet, or carpet tile as recited in claim 1, wherein the low face weight carpet is at least one of tufted and bonded.

25. The surface covering, wall covering, flooring, carpet, or carpet tile as recited in claim 1, wherein the low face weight carpet is aesthetically pleasing.

26. The surface covering, wall covering, flooring, carpet, or carpet tile as recited in claim 1, wherein the low face weight carpet is made from yarns of 1000-1700 denier.

27. The surface covering, wall covering, flooring, carpet, or carpet tile as recited in claim 1, wherein the cushion layer includes a foam layer of 14-18 lbs. per cubit foot density.

28. The surface covering, wall covering, flooring, carpet, or carpet tile as recited in claim 1, wherein the low face weight carpet is made using a non-heatset single yarn.

29. The surface covering, wall covering, flooring, carpet, or carpet tile as recited in claim 28, wherein the single yarn has a denier of about 1000-1400.

30. The surface covering, wall covering, flooring, carpet, or carpet tile as recited in claim 29, wherein the low face weight carpet has a non-woven backing and a latex coating.

31. The surface covering, wall covering, flooring, carpet, or carpet tile as recited in claim 1, wherein said low face weight carpet has a face weight of less than 20 oz/yd² and is jet dyed.

32. A low weight cushion backed carpet tile, comprising a low face weight primary carpet and a light weight cushion backing.

33. The carpet tile as recited in claim 32, wherein the low face weight is less than or equal to about 15 oz/yd .

34. The carpet tile as recited in claim 32, further comprising an adhesive layer between said carpet and cushion backing.

35. The carpet tile as recited in claim 34, wherein the adhesive layer is about 36-50 oz/yd².

36. The carpet tile as recited in claim 32, having resilience and under foot comfort.

37. The carpet tile as recited in claim 32, exhibiting performance characteristics that rate it for a heavy commercial use.

38. The carpet tile as recited in claim 34, further comprising a reinforcing material in or between at least one of said primary carpet, adhesive layer, and lightweight cushion.

39. The carpet tile as recited in claim 32, wherein the lightweight cushion is about 0.04-0.12 inches thick.

40. The carpet tile as recited in claim 32, wherein said lightweight cushion is about 0.04-0.09 inches thick.

41. The carpet tile as recited in claim 32, wherein the lightweight cushion has a polymer weight of less than about 15 oz/yd².

42. The carpet tile as recited in claim 32, wherein said lightweight cushion has a polymer weight of about 4.32-12.96 oz/yd².

43. The carpet tile as recited in claim 32, wherein said lightweight cushion is a polyurethane foam having about 110 parts of filler by weight.

44. The carpet tile as recited in claim 32, wherein the lightweight cushion has a polymer weight of about 2.72-8.24 oz/yd².

45. The carpet tile as recited in claim 32, wherein said lightweight cushion is a polyurethane foam with about 190 parts of filler by weight.

46. The carpet tile as recited in claim 32, wherein the lightweight cushion is an unfilled polyurethane.

47. The carpet tile as recited in claim 32, wherein said lightweight cushion has a density of about 6 lbs./per cubic foot and a polymer weight of about 2.88-8.64 oz/yd².

48. The carpet tile as recited in claim 32, wherein the lightweight cushion has a density of about 6-9 lb./cu. ft.

49. The carpet tile as restricted in claim 32, wherein said lightweight cushion is a polyurethane system with about 15 parts of filler material by weight and a polymer weight of about 4.30-13.02 oz/yd².

50. The carpet tile as recited in claim 32, wherein said lightweight cushion is at least one of a polyurethane foam and a water based foam system.

51. The carpet tile as recited in claim 32, wherein the lightweight cushion has a density of about 16 lbs. per cubic foot.

52. The carpet tile as recited in claim 32, wherein the low face weight carpet is at least one of tufted and bonded.

53. The carpet tile as recited in claim 32, wherein the low face weight carpet is aesthetically pleasing.

54. The carpet tile as recited in claim 32, wherein the low face weight carpet is made from a yarn with a denier of about 1000-1700.

55. The carpet tile as recited in claim 32, wherein the low weight cushion has a density of about 14-18 lbs. per cubic foot.

56. The carpet tile as recited in claim 32, wherein the low face weight carpet is made using a non-heatset single yarn.

57. The carpet tile as recited in claim 56, wherein the single yarn has a denier of about 1000-1400.

58. The carpet tile as recited in claim 32, wherein the low face weight carpet has a non-woven backing and a latex coating.

59. The carpet tile as recited in claim 32, wherein said low face weight carpet has a face weight of less than 20 oz/yd² and is jet dyed.

60. A low weight cushion backed carpet composite comprising a low weight primary carpet and a thin cushion backing.

61. The carpet composite as recited in claim 60, wherein the low weight carpet has a face weight of less than or equal to about 15 oz/yd².

62. The carpet composite as recited in claim 60, wherein the thin cushion backing is about 0.04-0.12 inches thick.

63. The carpet composite as recited in claim 60, wherein said thin cushion is about 0.04-0.09 inches thick.

64. The carpet composite as recited in claim 60, wherein the thin cushion has a polymer weight of less than about 15 oz/yd².

65. The carpet composite as recited in claim 60, wherein said thin cushion has a polymer weight of about 4.32-12.96 oz/yd².

66. The carpet composite as recited in claim 60, wherein said thin cushion is a polyurethane foam having about 110 parts of filler by weight.

67. The carpet composite as recited in claim 60, wherein the thin cushion has a polymer weight of about 2.72-8.24 oz/yd².

68. The carpet composite as recited in claim 60, wherein said thin cushion is a polyurethane foam with about 190 parts of filler by weight.

69. The carpet composite as recited in claim 60, wherein the thin cushion is an unfilled polyurethane.

70. The carpet composite as recited in claim 60, wherein said thin cushion has a density of about 6 lbs./per cubic foot and a polymer weight of about 2.88-8.64 oz/yd².

71. The carpet composite as recited in claim 60, wherein the thin cushion has a density of about 6-9 lb./cu. ft.

72. The carpet composite as restricted in claim 60, wherein said thin cushion is a polyurethane system with about 15 parts of filler material by weight and a polymer weight of about 4.30-13.02 oz/yd².

73. The carpet composite as recited in claim 60, wherein said thin cushion is at least one of a polyurethane foam and a water based foam system.

74. The carpet composite as recited in claim 60, wherein the thin cushion backing has a density of 16 lbs. per cubic foot.

75. The carpet composite as recited in claim 60, further comprising an adhesive layer between said primary carpet and said thin cushion backing.

76. The carpet composite as recited in claim 75, wherein the adhesive layer is less than or equal to about 50 oz/yd².

77. The carpet composite as recited in claim 75, further comprising a reinforcement material in or between at least one of said carpet, adhesive layer, and thin cushion backing.

78. The carpet composite as recited in claim 60, exhibiting performance characteristics that rate it for a heavy commercial use.

79. The carpet composite as recited in claim 60, having resilience and under foot comfort.

80. The carpet composite as recited in claim 60, wherein said composite is adapted to be cut into at least one of carpet, carpet tiles, runners, area rugs, floor mats, and the like.

81. The carpet composite as recited in claim 75, exhibiting performance characteristics that rate it for a heavy commercial use and having resilience and under foot comfort.

82. The carpet composite as recited in claim 77, exhibiting performance characteristics that rate it for heavy commercial use and having resilience and underfoot comfort.

83. The carpet composite as recited in claim 60, wherein the low weight carpet is at least one of tufted and bonded.

84. The carpet composite as recited in claim 60, wherein the low weight carpet is aesthetically pleasing.

85. The carpet composite as recited in claim 60, wherein the low weight carpet is made from a yarn having a denier of about 1000-1700.

86. The carpet composite as recited in claim 60, wherein the low weight cushion has a density of about 14-18 lbs. per cubic foot.

87. The carpet composite as recited in claim 60, wherein the low weight carpet is made using a non-heatset single yarn.

88. The carpet composite as recited in claim 87, wherein the single yarn has a denier of about 1000-1400.

89. The carpet composite as recited in claim 60, wherein the low weight carpet has a non-woven backing and a latex coating.

90. The carpet composite as recited in claim 60, wherein said low weight carpet has a face weight of less than 20 oz/yd² and is jet dyed.

91. A low weight cushion backed carpet tile, comprising a low weight primary carpet, a thin cushion backing and a hot melt layer between said primary carpet and thin cushion backing.

92. The carpet tile as recited in claim 91, wherein the carpet tile includes a reinforcement material in or between at least one of said primary carpet, hot melt layer, and thin cushion backing.

93. A low weight carpet tile, comprising a layered structure of a low weight primary carpet precursor, latex pre-coat adhesive, hot melt adhesive, fiberglass, polyurethane foam, and felt.

94. A low weight modular carpet tile, comprising a low face weight primary carpet, a hot melt layer including a reinforcing material, and a thin cushion layer having a non-woven backing.

95. A low weight modular carpet tile comprising a layered structure of a low face weight primary carpet, latex pre-coat adhesive, hot melt adhesive, fiberglass, polyurethane foam, and felt.

96. A low weight modular carpet tile comprising a layered structure of a low weight primary carpet, hot melt adhesive, polyurethane foam, and felt.

97. A low weight modular carpet tile comprising a layered structure of a low weight primary carpet, hot melt adhesive, fiberglass, and polyurethane foam.

98. A low weight modular carpet tile comprising a layered structure of a low weight primary carpet, hot melt adhesive, and polyurethane foam.

99. A low weight modular carpet tile comprising a layered structure of a low weight primary carpet, bitumen hot melt layer, fiberglass, polyurethane foam, and felt.

100. A low weight modular carpet tile comprising a layered structure of a low weight primary carpet, a first layer of hot melt adhesive, fiberglass, a second layer of hot melt adhesive, polyurethane foam, and felt.

101. A low weight modular carpet tile comprising a layered structure of a low weight primary carpet, a first layer of hot melt adhesive, a fiberglass, a second layer of hot melt adhesive, polyurethane foam, and felt.

102. A low weight modular carpet tile comprising a layered structure of a low weight primary carpet precursor, fiberglass, latex pre-coat adhesive, hot melt adhesive, polyurethane foam, and felt.

103. A method of forming a low weight modular carpet tile comprising the steps of: adhesively bonding a layer of glass reinforcement material to the base of a low weight primary carpet fabric having a face weight of less than or equal to about 15 oz/yd² to form a laminate composite,
placing a layer of wet polyurethane-foam forming composition into direct contact relation with a layer of non-woven backing material to form a polyurethane foam layer of about 0.04-0.12 inches thick,
joining the polyurethane foam layer to the glass reinforcement material to form a low weight modular carpet composite, and cutting carpet tiles from the carpet composite.

104. The method as recited in claim 103, wherein said step of adhesively bonding the layer of glass reinforcement to the base of the primary carpet fabric utilizes a hot melt layer of about 36-50 oz/yd².

105. A method of forming a low weight modular carpet composite comprising the steps of:
adhesively bonding a layer of glass reinforcement material to the base of a low weight primary carpet fabric to form a laminate composite, and placing a layer of wet polyurethane-forming composition into direct contacting relation with the glass reinforcement material in a manner providing a polyurethane foam layer of about 0.04-0.12 inches thick.

106. The method as recited in claim 105, wherein the adhesively bonding of the glass reinforcement material to the base of the primary carpet fabric forms a hot melt layer of about 36-50 oz/yd².

107. A process for the formation of a floor carpet tile whereby the tile produced is suitable for disposition as discrete modular units across a flooring surface, the process comprising the steps of:
applying a layer of latex pre-coat adhesive to the back of a low weight primary carpet fabric,
applying a hot melt adhesive over the latex pre-coat,
forming a layer of polyurethane foam on at least one of a woven or non-woven backing material, and joining the polyurethane foam to the hot melt adhesive to form a low weight modular carpet composite, and
cutting carpet tiles from the carpet composite.

108. The method as recited in claim 107, wherein the low weight primary carpet has a face weight of less than or equal to about 15 oz/yd², the polyurethane foam layer is about 0.04-0.12 inches thick, and the hot melt layer is about 36-50 oz/yd².

109. The method as recited in claim 107, further comprising the step of adding a reinforcement material between said hot melt adhesive and said polyurethane foam.

110. A low weight carpet tile produced by the process claim 103.

111. A low weight carpet composite produced by the process claim 105.

112. A floor carpet tile produced by the process of claim 107.

113. A floor carpet tile produced by the process of claim 109.

114. A surface covering such as wall covering, panel covering, flooring, floor covering, carpet, carpet tile, or the like comprising: a low face weight material and cushion back.

115. The covering as recited in claim 114, wherein the material has an upper and lower surface, and the cushion back is attached to the lower surface of said material.

116. The covering as recited in claim 114, wherein the covering is a floor covering.

117. The covering as recited in claim 114, wherein the cushion back is low weight.

118. The covering as recited in claim 114, wherein the material is a pile material.

119. The covering as recited in claim 114, wherein the low face weight is less than about 20 oz/yd².

120. The covering as recited in claim 114, wherein the low face weight is less than or equal to about 15 oz/yd².

121. The covering as recited in claim 114, wherein the low face weight is less than or equal to about 12 oz/yd².

122. The covering as recited in claim 114, wherein the material has an upper surface having at least one of a design, color, pattern, and combinations thereof.

123. The covering as recited in claim 122, wherein the design, color, pattern, and combinations thereof are made by at least one of injection dying, jet dying, printing, and combinations thereof.

124. The covering as recited in claim 114, wherein the material is a tufted pile material made from a yarn having a twist of less than one.

125. The covering as recited in claim 114, wherein the material is a tufted pile material made from at least one of a natural and synthetic yarn.

126. The covering as recited in claim 114, wherein the material is at least a portion of a tufted pile broadloom material.

127. The covering as recited in claim 126 wherein the tufted pile broadloom material has an upper pile face having at least one of a design, color, pattern, and combinations thereof.

128. The covering as recited in claim 127 wherein the at least one design, color, pattern, and combinations thereof are made thereon by at least one of injection dying, jet dying, printing, and combinations thereof on broadloom.

129. The covering as recited in claim 114, wherein the covering has a Hexapod rating of at least 3.

130. The covering as recited in claim 114, wherein the covering has resilience and under foot comfort.

131. The covering as recited in claim 114, wherein the covering has a Gmax test result of less than 130.

132. The covering as recited in claim 114, wherein the covering has a resilience rating of greater than 25.

133. The covering as recited in claim 114, wherein the covering exhibits performance characteristics that rate it for heavy commercial use.

134. The covering as recited in claim 114, wherein the covering has an Appearance Retention Rating (ARR) of at least 3.5 long term and at least 4.0 short term.

135. The covering as recited in claim 114, wherein the covering has a Hexapod test color change test result of only slight or moderate color change.

136. The covering as recited in claim 114, wherein the covering has a Hexapod test pile height retention result of a pile height retention of at least about 74%.

137. The covering as recited in claim 114, wherein the covering has an intermediate layer between said material and said cushion back.

138. The covering as recited in claim 137, wherein the intermediate layer is a resilient layer made of hot melt a nd a fiberglass material.

139. A surface covering such as flooring, floor covering, carpet, carpet tile, or the like comprising: a low face weight material having a face weight of less than about 20 oz/yd², and a cushion back.

140. A surface covering such as flooring, floor covering, carpet, carpet tile, or the like comprising: a low face weight material having a face weight of less than about 20 oz/yd², a cushion back, and a Hexapod rating of at least 3.

141. A surface covering such as flooring, floor covering, carpet, carpet tile, or the like comprising: a low face weight material having a face weight of less than about 20 oz/yd², a cushion back, and a resilience and under foot comfort.

142. A surface covering such as flooring, floor covering, carpet, carpet tile, or the like comprising: a low face weight material having a face weight of less than about 20 oz/yd², a cushion back, and a Gmax test result of less than 130.

143. A surface covering such as flooring, floor covering, carpet, carpet tile, or the like comprising: a low face weight material having a face weight of less than about 20 oz/yd², a cushion back, and a resilience rating of greater than 25.

144. A surface covering such as flooring, floor covering, carpet, carpet tile, or the like comprising: a low face weight material having a face weight of less than about 20 oz/yd², a cushion back, and an Appearance Retention Rating (ARR) of at least 3.5 long term and at least 4.0 short term.

145. A surface covering such as flooring, floor covering, carpet, carpet tile, or the like comprising: a low face weight material having a face weight of less than about 20 oz/yd², a cushion back, and a Hexapod test color change test result of only slight or moderate color change.

146. A surface covering such as flooring, floor covering, carpet, carpet tile, or the like comprising: a low face weight material having a face weight of less than about 20 oz/yd², a cushion back, and a Hexapod test pile height retention result of a pile height retention of at least about 74%.

147. A surface covering such as flooring, floor covering, carpet, carpet tile, or the like comprising: a low face weight material having a face weight of less than about 20 oz/yd², a cushion back, and an intermediate layer between said material and said cushion back.

148. The covering as recited in claim 147, wherein the intermediate layer is a resilient layer made of hot melt and a reinforcement material.

149. A surface covering such as flooring, floor covering, carpet, carpet tile, or the like comprising: a low face weight material having a face weight of less than about 20 oz/yd², a cushion back, and a reinforcing material in at least one of said material, said cushion back, and between said material and said cushion back.

150. A flooring, floor covering, carpet, carpet tile, or the like comprising: a low face weight material, an intermediate layer, and a cushion back.

151. The flooring as recited in claim 150, having good seamability.

152. The flooring as recited in claim 150, having a patterned monolithic design.

153. The flooring as recited in claim 150, having a uniformity of appearance between tiles.

154. The flooring as recited in claim 150, having a constant shade on tiles from the same dye lot.

155. The flooring as recited in claim 150, having at least one of durability, low crush, short pile, dense surface, and combinations thereof.

156. A method of marketing carpet to carpet customers, comprising the steps of offering to the customer at least one of each of standard cushion back carpet tile, low weight cushion back carpet tile and hardback carpet tile to satisfy all of their carpet needs and thereby replace broadloom carpet.

157. A method of marketing carpet tile as a replacement for broadloom, comprising the steps of offering low weight cushion back carpet tile for sale at the same price as installed cost broadloom.

158. A substrate for jet dyeing pattern carpet, comprising:
a low weight pile material adapted to be jet dyed,
and a low weight cushion backing.

159. The substrate of claim 158, further comprising an adhesive layer between said pile material and said cushion backing.

160. The substrate of claim 159, further comprising a reinforcement material in or between at least one of said pile material, adhesive layer, and cushion backing.

161. The substrate of claim 158, wherein said pile material is heat set after dyeing.
